(19) United States
(12) Patent Application Publication
(10) Pub. No.: US 2012/0047082 A1
(43) Pub. Date: Feb. 23, 2012

(54) ON-LINE PROPERTY ASSET SYSTEM AND METHOD

(75) Inventor: John Bodrozic, El Dorado Hills, CA (US)

(73) Assignee: Homezada, Inc., El Dorado Hills, CA (US)

(21) Appl. No.: 13/212,040

(22) Filed: Aug. 17, 2011

Related U.S. Application Data
(60) Provisional application No. 61/374,543, filed on Aug. 17, 2010.

(51) Int. Cl. G06Q 50/16; G06F 17/30

(52) U.S. Cl. 705/314; 707/792

(57) ABSTRACT

A system and method for managing a home/property is disclosed in which the assets of a home/property may be managed. The assets may include location assets (e.g., a location of the property or house such as the backyard or first floor), fixed assets (e.g., equipment that is typically sold with a house/property such as a furnace) and furnishing assets (e.g., assets that a owner will typically take when the house/property is sold such as a billiards table or a television).

### PRIORITY CLAIMS/RELATED APPLICATIONS

This application claims the benefit from under 35 USC 119(e) and priority under 35 USC 120 to U.S. Provisional Patent Application Ser. No. 61/374,543 filed on Aug. 17, 2010 and entitled “ON-LINE PROPERTY ASSET SYSTEM AND METHOD”, the entirety of which is incorporated herein by reference.

### FIELD

The disclosure relates generally to a system for managing a home/property and in particular to a system and method for managing one or more assets of a home/property.

### BACKGROUND

Systems exist that permit a user to generate and store an inventory of the items in a home. These systems, that may be web based or personal computer based, allow the user to inventory items for insurance coverage, insurance claims and the like. These system may include DocuHome (www.docuhome.com), What You Own (www.whatyouown.org), Know Your Stuff (www.knowyourstuff.org), Clearly Inventory (www.clearlyinventory.com), Quicken Home Inventory Manager (http://quicken.intuit.com/personal-finance-software/home-inventory-manager.jsp), My Edge Home Inventory (www.myedgesoftware.com), Liberty Street Software (http://www.libertystreet.com/Asset-Home-Inventory.htm), Contact Plus Software (htt://www.contactplus.com/Home-Invento/Home-Invento-Software.html, Stuff Safe (http://www.stuffsafe.com/), A Safe Spot (http://www.asafespot.com/), MOHI (www.myonlinehomeinventory.com), The Complete Home Journal (http://www.thehomejournal.com/), Computerize Your Home Assets (http://www.cya2 day.com/), Inventory Solutions (www.inventorysolutionsonline.net), Red Queen Software (http://www.redqueensoftware.com/Packaged-Software-Solutions/index.shtml) and My Croft Computing (http://www.mycroftcomputing.com/eiown.html).

System also exist that permit a user to manage property/home maintenance. These system may include ProHomeManager (http://www.prohomemanager.com/Default.asp) and Kaizen Software Solutions (http://www.kzsoftware.com/products/home-inventory-software/Home Manager).

However, the above home inventory systems and home maintenance systems do not have an ability to expose certain assets to the public for a sale of the home/property, do not have an ability to transfer the assets at the time of the sale, do not have the ability to move/merge old/new assets and do not permit the transfer of maintenance history. These system do not have the ability to manage home improvement projects and link those to the inventory of the home and they do not have an algorithm to prompt the user with news and alerts to remind the user or to suggest to the user ways to improve their home inventory or to add checklists to their property calendar to properly maintain their home. These systems also do not have a community area where users can share best practice checklists, recommended service providers, and build virtual neighborhood watches with other users. These systems also do not have the ability to pre-populate a property with inventory thus eliminating the need for the user to manually enter every inventory item. Thus, it is desirable to provide an on-line property asset system and method that provides one or more of these features missing from existing system and it is to this end that the disclosure is directed.

### BRIEF DESCRIPTION OF THE DRAWINGS

FIG. 1 illustrates an example of the public facing website for a property asset system;

FIG. 2 illustrates an example of a customer accounts portion of the property asset system;

FIG. 3 illustrates an example of a property portion of the property asset system;

FIG. 4 illustrates an example of an inventory portion of the property asset system;

FIG. 5 illustrates an example of a to do workspace portion of the property asset system;

FIG. 6 illustrates an example of a projects portion of the property asset system;

FIG. 7 illustrates an example of a dashboard portion of the property asset system;

FIG. 8 illustrates an example of a news and alerts workspace of the property asset system;

FIG. 9 illustrates an example of a community workspace of the property asset system;

FIG. 10 illustrates an example of an administrative functions portion of the property asset system;

FIG. 11 an example of an affiliate partner account of the property asset system;

FIG. 12 an example of linking property checklists to inventory items in the property asset system;

FIG. 13 an example of linking project design items to various inventory items in the property asset system;

FIG. 14 illustrates partner created property transferred to a customer account using the property asset system;

FIGS. 15 and 16 illustrate a community checklist workflow;

FIG. 17 illustrates a new property template of the property asset system;

FIG. 18 illustrates an example use case of a user making a property public using the property asset system;

FIG. 19 illustrates another use case of a seller transferring property and fixed assets to the property asset system;

FIG. 20 illustrates another use case of a seller managing their own inventory items using the property asset system;

FIG. 21 illustrates another use case of a new user importing an existing property and fixed item inventory to the property asset system;

FIG. 22 illustrates another use case of an existing user merging possessions with existing property and fixed items using the property asset system;

FIGS. 23-25 illustrate details of a mobile application for the property asset system;

FIGS. 26A-26B each illustrate an example of an implementation of a web-based property asset system;

FIGS. 27A-D are examples of a home screen user interface of the property asset system;

FIG. 28 is an example of a login user interface of the property asset system;

FIG. 29 is an example of a news and alerts user interface of the property asset system;

FIG. 30 is an example of a dashboard of Possession Inventory Item Value user interface of the property asset system;

FIG. 31 is an example of a dashboard of fixed items value user interface of the property asset system;

FIG. 32 is an example of a inventory value by room user interface of the property asset system;

FIG. 33 is an example of a monthly maintenance cost user interface of the property asset system;

FIG. 34 is an example of a dashboard of monthly costs by type user interface of the property asset system;

FIG. 35 is an example of an inventory of all spaces in a property user interface of the property asset system;

FIG. 36 is an example of a kitchen space with inventory items user interface of the property asset system;

FIG. 37 is an example of an inventory item detail user interface of the property asset system;

FIG. 38 is an example of an inventory item image uploads user interface of the property asset system;

FIG. 39 is an example of an inventory document upload user interface of the property asset system;

FIG. 40 is an example of a checklist library user interface of the property asset system;

FIG. 41 is an example of an add an item to the checklist user interface of the property asset system;

FIG. 42 is an example of a property checklist user interface of the property asset system;

FIG. 43 is an example of a property checklist linked to inventory space and item user interface of the property asset system;

FIG. 44 is an example of a calendar view of to dos user interface of the property asset system;

FIG. 45 is an example of a to do list user interface of the property asset system;

FIG. 46 is an example of an ad hoc to do user interface of the property asset system;

FIG. 47 is an example of a community user interface of the property asset system;

FIG. 48 is an example of a property details user interface of the property asset system;

FIG. 49 is an example of a property images user interface of the property asset system; and

FIG. 50 is an example of a property documents user interface of the property asset system.

### DETAILED DESCRIPTION OF ONE OR MORE EMBODIMENTS

The disclosure is particularly applicable to a web-based property asset system and method with an implementation known as Homezada and it is in this context that the disclosure will be described. It will be appreciated, however, that the system and method has greater utility since it can be implemented in other manners and with other elements/architectures that would be within the scope of this disclosure.

HomeZada is an online hosted software system that provides property owners with the ability to manage, organize and protect their property with a centralized system for all the electronic records of their property and all the associated inventory items. It combines multiple features into one application including a home inventory, home maintenance, home to dos, home spending, home improvement projects, and buying and selling a property. The properties can include various kinds of property such as single family homes, townhouses, condominiums, estates, ranches, commercial buildings, office buildings, etc. The property is broken down into multiple Spaces that can be the various rooms in a house as well as areas outside the house. Inventory items are assigned to a Space and are broken down into two key asset types that include fixed inventory items, and possession inventory items. These inventory items have important attributes that the property owner can track such as equipment manuals, warranty expiration dates, dates of purchase, initial cost of purchase, etc. The property owner can also associate electronic pictures, videos, and documents of their inventory for record keeping purposes. Many fixed and possession types of inventory include web interfaces to manage those inventory items. HomeZada provides a central location, like an overall portal concept, to associate all the property owner's inventory items which have web interfaces like today's modern appliances, security systems, and utility meters connected to the Internet.

The property asset system provides the ability to create ad hoc to dos and link them to inventory and assign them to dos to various people who are responsible for executing on the to do. HomeZada also provides the property owner the ability to create property checklists which can be linked to various inventory items. The property owner also determines the frequency that the property asset system should execute on the property checklists. When HomeZada executes a property checklist, it creates a to do for the associated inventory that are linked to it. HomeZada also provides a library of common property checklists for various kinds of common property inventory that each property can browse from and chose to copy for their own use within their own account and property record.

The property asset system provides the property owner the ability to create and manage projects within their property. The project system allows the user to create multiple projects within a property. Each project can then manage and track the scope or design items, budgets, schedule, and contracts or purchase orders within each project. The system also provides a portfolio dashboard of all the projects associated with the property.

HomeZada also has a news and alerts series of functions that proactively remind the user about various things regarding their property. There are multiple types of news items such as reminders and overdue reminders regarding the user to dos. Another type of news item is an inventory suggestion, where the system will query the database and tell the user that certain inventory items do not have any photos, or there is no owner's manual, or there is no purchased date or purchased price. Another type of news feed is a suggestion or recommendation based on the HomeZada library of property checklists. These can be one checklist at a time, or a logical grouping of multiple checklists based on the four seasons of the year, or even based on severe weather patterns based on the property's location. Another news type are home safety tips as well as product tips on best practices for maintaining the property.

HomeZada provides administrative functions such as maintaining attributes about their property such as the address, size, GPS location, floor plans, landscaping plans, etc. The system also allows the property owner to create companies and contacts to manage what third parties service their properties. The system can also create security rights for each contact on what portion of the system they have access to create, read, update, or delete information.

HomeZada provides each user that has the rights to login to an account and view a specific property multiple dashboards. These dashboards include personal dashboards specific to the contact which instantly tells the user what to dos they are responsible for, when they are do, and what inventory they are associated with. Dashboards can also be property specific that show all the to dos associated with the property regardless of who is responsible for executing the work on the to do. Other dashboards include a maintenance cost history indicating the maintenance costs of the property associated with all the to dos, and an asset cost history indicating the initially costs of any asset. HomeZada also provides the user the ability to create links to any other aspect of the system.

HomeZada is a system that hosts multiple customers' properties and their associated inventory. As a result of this centralized storage of multiple property information, HomeZada provides other key community and brokerage types of functionality. By default, an account and the associated property and asset information is confidential from all the other users. Only the account owner with the appropriate login can access their property and the associated inventory.

HomeZada also provides a number of features around community concepts. These community features are available to all HomeZada account holders and provides them a mechanism to share information with each other. A user of HomeZada can create their own property checklist that includes what needs to be done, the frequency and the time of year, as well as any how to instructions. The user can choose to publish this to a Community Property Checklist, which then allows all other users of HomeZada to review user published property checklists, and they can chose to add those to their own specific Property checklist.

Other Community features include the ability to publish contact information about service providers and provide a referral and recommendation to the other community user of HomeZada as a directory. In addition, within the Community framework, users can create Virtual Neighborhood Watches where a group of HomeZada users within the same neighborhood can share information to keep the neighborhood safe. Users can create incidents that log dates, times, photographs and descriptions of activities that other Community members can view and comment on. Users can also see maps of their neighborhoods to see who else in the area is a HomeZada user.

The property asset system does allow an account owner to make the property public. Once the account owner executes this action, the property becomes searchable in HomeZada's public areas of the system that does not require a login. This scenario is based on the scenario where a current owner of a specific property is trying to sell their property, and they are interested in the public searchable aspects of the property asset system to attract potential buyers. Buyers can access HomeZada's public areas of the site, and search for properties by various attributes including state, county, city, zip code, etc. Once the search is executed and the results are displayed, the potential buyer can click on the property to learn more of the details, and actually view the properties location, the Spaces in the property and the fixed inventory items, and other associated information the current owner is choosing to make public such as specific equipment and pictures. The property asset system simultaneously allows the current owner of the property to continue managing their property, inventory, to dos, projects, etc., yet make only a portion of the information such as the properties attributes as well as specific spaces and fixed inventory items public and searchable.

The property asset system also acts as a broker or intermediary between a buyer and seller of a property and its specific location and fixed inventory. The scenario here is when a seller of a property has a detailed account of a properties spaces and fixed inventory items, and associated maintenance records and property checklists for those inventory items. Once a buyer takes ownership of the same property, the seller makes those electronic records of the properties inventory available for the buyer to carry forward and continue to maintain in the property asset system.

The property asset system manages this transfer in a number of steps. The seller or current owner of the property executes a command to transfer the property, the spaces and fixed inventory items, and the associated property checklists to a secure area of the property asset system. Once this action is taken, the current owner maintains a generic account with all of their personal possession inventory items that are obviously not part of the sale of the property. The buyer of the seller's property creates an account on the property asset system, and once confirmation that the property has officially been sold, the property asset system makes the property available to the new buyer to import the same detailed account of the property, spaces and fixed inventory items, as well as property checklists.

The original seller of the property might buy a new property. This scenario is where the seller has an account and a generic property on the system, with only their possessions as their inventory. After HomeZada makes a new property available to them, then can now combine the spaces and fixed inventory items of a new property with their existing possession inventory items in one asset hierarchy. The can re-arrange the hierarchy of all the inventory items as they desire.

Structure of the System

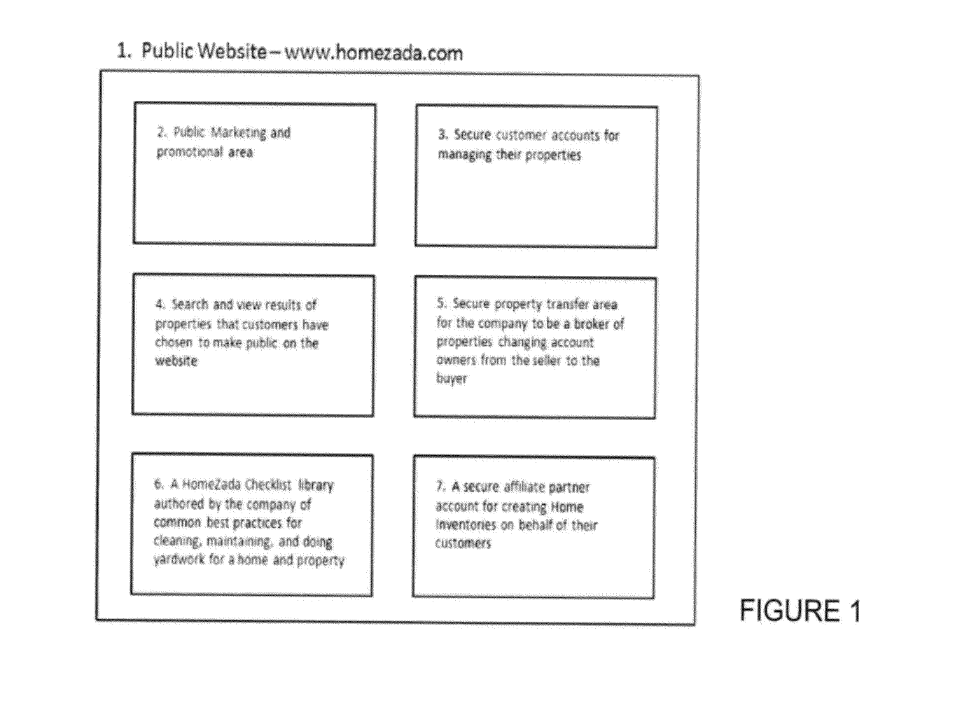

The overall structure of the property asset system is a series of multiple layers that are combined together to provide multiple levels of functionality. FIG. 1 depicts the highest layer of the solution, with item 1 being the overall system at HomeZada.com. Item 2 are the portions of the system that dedicated to public marketing and promotion explaining how the overall system works to potential customers. Item 3 is the section of the system devoted to customers who have registered accounts to manage one or more properties. Item 4 is the area of the system devoted to those properties that customers have chosen to make public, and thus make a subset of all of HomeZada's properties available to public searching and access of those properties.

Item 5 of the overall system is the section of the system that manages properties that are being transferring and imported to different buyers and sellers of properties, and thus the electronic records of those properties changing from one account owner to another account owner in the system. Item 6 is a library of best practices that is published by HomeZada and is made available freely to public visitors of the site. These best practices are broken down into three categories, which include cleaning best practices, maintenance best practices, and yard work or outside the home best practices. Each best practice has a suggested frequency over how often the task should be performed, as well as monthly recommendations on when the tasks should be performed. Item 7 is a secure area where affiliated business partners of HomeZada such as home builders, insurance companies, insurance brokers, real estate agents and brokers, home inventory service companies, etc. login to the partner account which allows them to setup a specific property for their customers on their behalf, and then turn over the property to be managed by the customer.

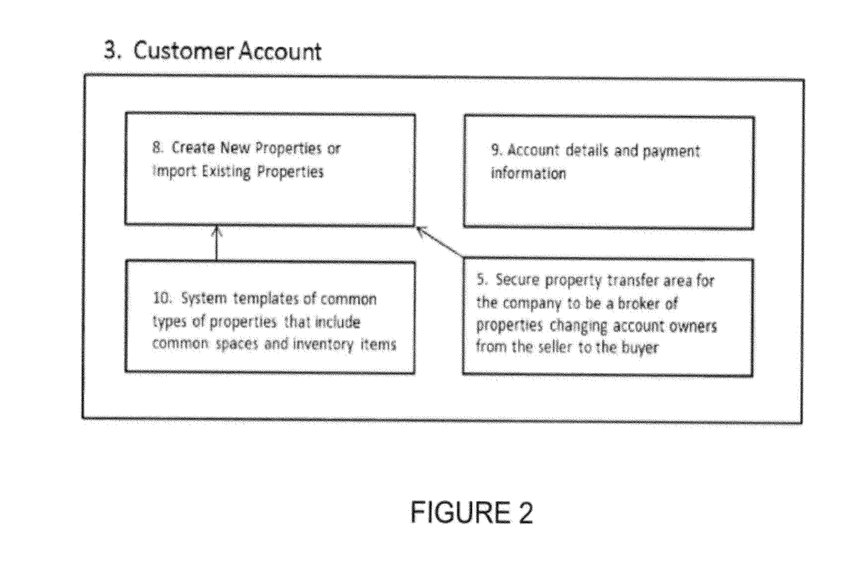

The next layer of the system drills down into the secure customer account area. FIG. 2 depicts the overall customer account functionality. Item 8 is the area of the system where a customer can create one or more properties that they own and would like to manage. Item 9 is the section of the system that describes the account owner as well as their payment method for the use of the system.

Item 10 of FIG. 2 is a system section of HomeZada that has a number of common templates for various kinds of properties. These templates can be for single family homes that have 3, 4, 5, etc. bedroom houses with various bathrooms, that could be either single story or multi-story. These templates can also be for other types of properties like townhouses, condominiums, estates, ranches, etc. Templates will also be based on typical floor plans and templates from various new home builders across the country, so that customers who buy new homes directly from home builders can select that home builders template when they create their property. Item 5 links to item 8 which provides the user the ability to create a new property. However, if that property already exists in the system area of Item 5, where a previous owner of that specific property has sold it and transferred the property back to HomeZada to manage, the user can inherit the previous property information instead of creating a new property from a generic template in Item 10.

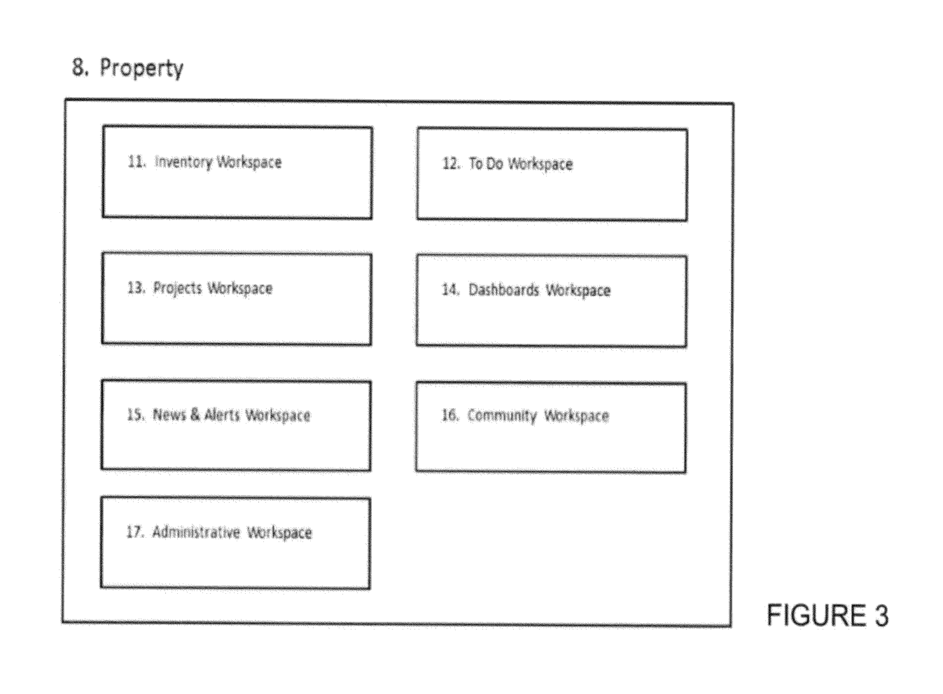

The next layer of the property asset system is depicted if FIG. 3 and starts with the overall aspect of a property. The property layer of the system has 7 key subcomponents of the system. Item 11 is the area of the property to create and manage all the various inventory incorporated into a single property. Item 12 is the section of the property where the user can create and manage all the to dos associated with the property. Item 13 is the area of the system where the user can create and manage all the projects within the property. Item 14 is the area of the system where dashboards are built to help users of the system manage the work and costs associated with the property. Item 15 is the area of the system where the user receives intelligent and smart alerts and news items regarding their property including suggested recommendations from HomeZada on best practices to organize, protect and maintain the property. Item 16 is an area of the application that is not specific to the user's property, but it is a community area where all users who have HomeZada accounts can post, publish and view information that is that is common information all home owners may be interested in. Item 17 is the section where the user can perform various administrative functions associated with maintaining the property.

The next layer of the property asset system drills down into each of the 7 areas of the system in FIG. 3. The next key area of the system is the inventory area. The first level down within a property is the concept of a Space. Spaces are typically the names of the various rooms inside a house, such as kitchen, family room, master bedroom, bathroom etc. Spaces are also used to categorize areas out the house such as front yard, back yard, pool area, etc. The user can upload pictures, as indicated in Item 19, and assign them to a space, and can also provide descriptions and dimensions of the space.

The next level down is that each Space can contain unlimited Inventory Items. There are two distinct kinds of Inventory Items. One is a Fixed Inventory Item and Asset, as shown in Item 20, and the other is a Possession Inventory Item and Asset, as shown in Item 21. A Fixed Inventory Item is a type of asset that is fixed to the property and is usually sold with the property. There are 4 kinds of Fixed Inventory Items which include Equipment, such as air conditioning units, furnaces, etc., Building Materials such as plumbing fixtures, doors and windows, floors, etc., Landscaping such as trees, lawns, pools, etc. and Major Appliances such as ovens, stoves, and refrigerators.

A Possession Inventory Item and Asset is a type of asset that is not fixed to the property and the user will usually move these items from one home to the next. There are 8 different types of possession inventory items including Furniture, Decorative Items, Collectibles, Electronics, Housewares, Personal Items, Tools, and Small Appliances.

A user can create as many Spaces as necessary to categorize a property, and the user can create as many fixed or possession inventory items and assign them to a specific space as well. This flexibility of the system design thus allows all users to match the level of hierarchy of the particular property, no matter whether it is a single or multi story home, and no matter how rooms the home has. The system can also handle a property with multiple structures on it, such as a ranch or estate with multiple homes on the same property.

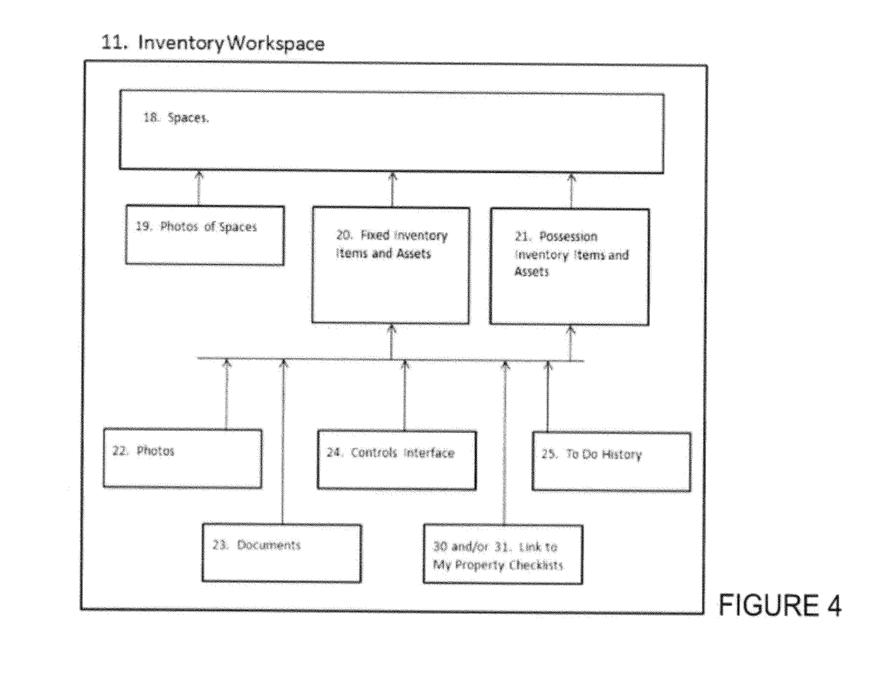

Item 22 in FIG. 4 depicts the system's ability to upload, view and assign multiple photos and videos to any and all of two different kinds of inventory items. This allows the property owner to visually document their entire inventory in their property and link it to the electronic record of that inventory. Item 23 depicts the system's ability to upload and view any document related to an inventory items, such as owner's manuals, receipts, warranty documents, and product registration cards. In addition, both kinds of inventory items can be linked to property checklists of the property as shown Item 30 and/or Item 31. The system also shows the user all previous to do history for which is shown as item 25.

Many pieces of equipment today have a web user interface that allows the owner of that equipment the ability to view and manage the equipment remotely via the internet. Security camera feeds, satellite television receivers, home energy management systems, smart appliances, and utility meters are a few examples of equipment systems that provide web user interfaces. The property asset system provides the ability to link any of the two different types of inventory items to the internet links of those particular systems. HomeZada is aggregating all the different asset types in one internet system, but providing essentially a portal control interface to each individual piece of equipment that supports it.

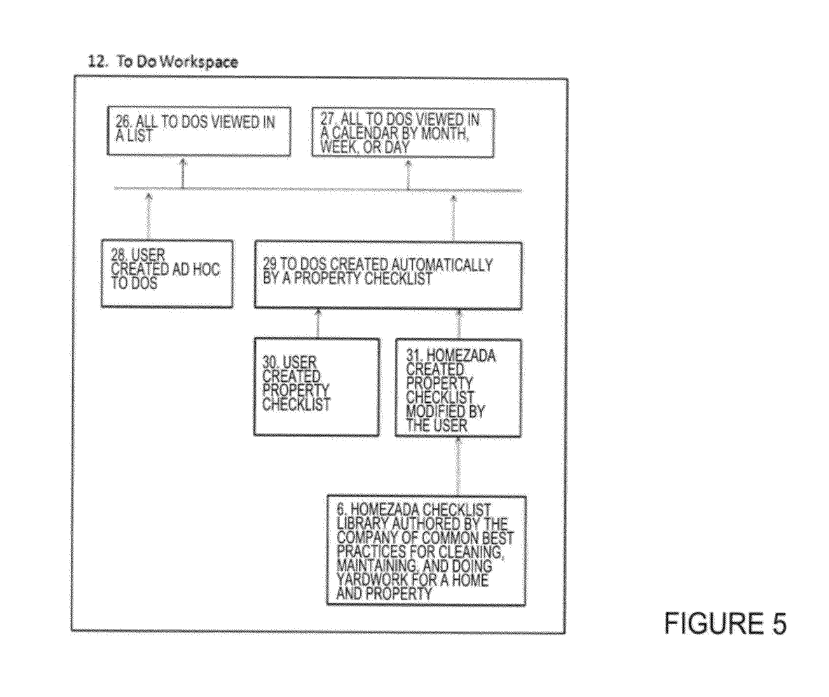

The next major area of the application is the To Dos. This area of the application combines suggestion and recommendation content for cleaning, maintaining, and doing yardwork on a property authored by HomeZada as well as providing the user the ability to create their own unique property checklists. In FIG. 5, Item 6 is a library of best practice recommendations authored by HomeZada and presented to the user. There are three different kinds of recommendations which including best practices for cleaning a house, maintaining key equipment and materials in home, and routines for lawn, garden and other general outdoor yardwork tasks. Each item in the library comes with a suggested frequency on how often the task should be performed, as well as a monthly and seasonal recommendation on when in the year certain tasks should be performed. The user can add these recommendations to their specific property and when doing so, they can assign a person or company to be responsible for the tasks, they can assign their own start date of the task, and they can change the suggested frequency based on their own desires. Once they have performed this function, these become Property Checklists as indicated in Item 31 in FIG. 5.

In Item 30, the user can create their own Property Checklists by entering in the tasks and descriptions, as well as a responsible party and a start date and frequency. Thus a property can have multiple regular checklists that are both authored by HomeZada and adopted by the user, and the user created their own. As an example, some checklists may have a suggested frequency of once a week, or once a month, or 4 times a year, etc. Property Checklist can also be linked to both Spaces and any Inventory Item within the property.

HomeZada now has a scheduling engine that monitors these checklists and automatically creates a years' worth of specific To Dos for each checklist. As an example, the Property Checklist could be to replace the air conditioning filters 4 times year. HomeZada would automatically create 4 different to dos for the next 12 months and place them on a calendar. These automatically created to dos from the property checklists are shown in Item 29 in FIG. 5. In addition, Item 28 in FIG. 5 illustrates that the user can create ad hoc to dos for virtually anything, like a grocery list or a fix it to do for something that is broken in the home or property.

All of the To Dos, regardless of whether they are system created or user created are now viewable by the user in a simple list view, as depicted in Item 26, or in a calendar view, as depicted in Item 27 in FIG. 5. The calendar view allows the user to view all To Dos by month, week or by day. Both the list view and the calendar view allows the user to filter down the list of to dos by responsible party, by the type of to do, or by a future-period of time such as the next day, the next 7 days, the next 14 days, the next month, etc.

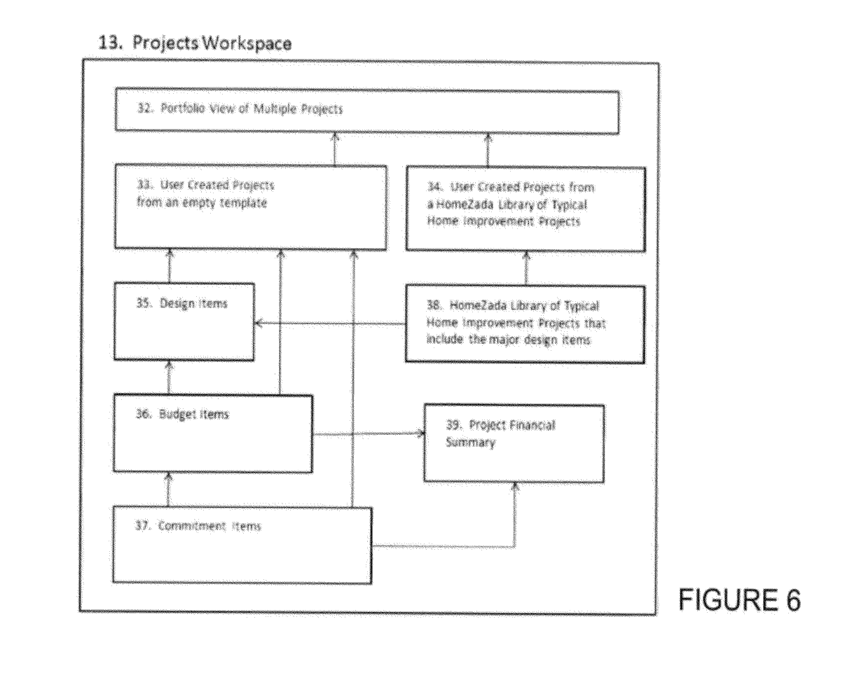

Another major feature of the system is to manage home improvement projects within the property. FIG. 6 depicts the major components of the project aspect of the system. Item 33 is a feature that aggregates multiple projects in a portfolio type of dashboards that provides visibility to the overall status of all the projects in the system attached to the current property. Item 27 is that area that allows the user to create new projects which can be for various kinds of projects on a property like a house remodel or additional landscape.

Item 38 is a library of typical home improvement projects authored by HomeZada. An example of some of these projects include a kitchen remodel, a bathroom remodel, a new roof project, a new pool, or an extension to the existing house. The user can create new projects in the system by using the HomeZada library, which is depicted in Item 34. The HomeZada library already includes all the common design items that need to be purchased to perform that improvement project. These design items include all necessary materials and equipment that need to be purchased, as well the labor to demolish the existing assets and the labor to install the new items.

Once a project is created, the system can create multiple design items. A design item includes a description of the item, along with attributes such color, size, manufacturer, etc. which is shown in item 35. Budget items are another feature to allow the user to create multiple items to create an overall budget for a project. Each item can be classified as an original budget item, as a changed budget item, and can also be linked to an existing design item. Budget items also can track budgeted quantities and unit rates and all of this functionality is shown as item 36.

Commitment items are designed to track items that have been bought or contracted via a purchase order, contract, invoice and receipt. Commitment items are also linked to a specific project, and can optionally be linked to budget items and are shown as item 37. Item 39 compares budget items with commitment items for both original budget items as well as change items which provides an overall project financial summary.

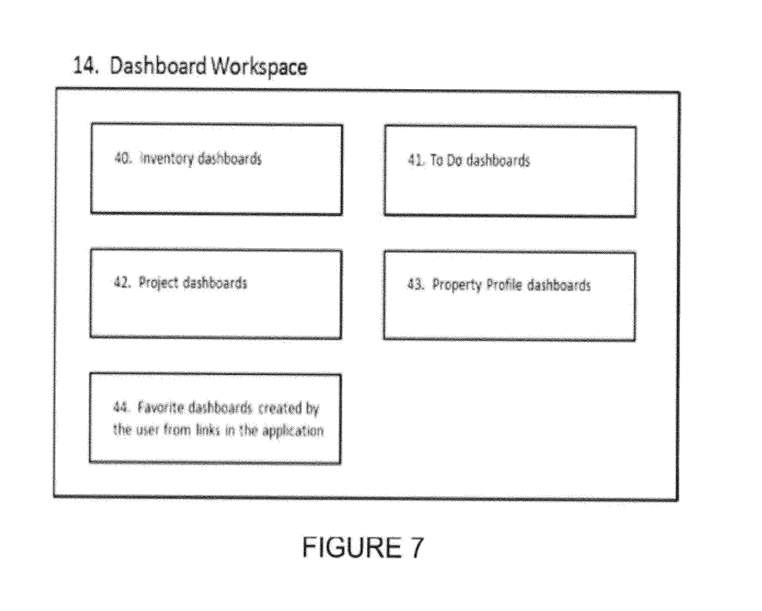

The next section of the system is a series of dashboards. Item 40 in FIG. 7 illustrates a feature of the application where the user can view multiple inventory dashboards. These dashboards show the user the total asset value of their inventory broken down by both fixed items and possession items. Each of the fixed and possession subcategories are also show. In addition, the user can see a bar chart by year and month of when those purchases were made as part of their overall inventory. Item 40 shows multiple dashboards based on the historical and future To Dos in the system. The user can see all the to do costs grouped by type of To Dos, such as cleaning, maintenance, fix it, yardwork, and other categories. This shows the user the total maintenance costs for the property. The user can also see the monthly to do costs for each year, as well as a bar chart showing how many to dos each person has either done or is assigned to them in the future.

Item 42 shows the user all the improvement projects associated with the property including the key status of each project, on whether the project is still in a planning stage, or in progress stage, or the project has been completed. The dashboard shows the user the amount of each project and how much money has been put into the house. Item 43 shows property profile dashboards which shows the user how many spaces are in the inventory, and how many inventory items are in the property. These are also grouped by the inventory category. It gives the user a quick glance over how many photos are uploaded and how many owner's manuals are in the system. Item 44 allows the user view any other page in the application that they have tagged as a favorite. The dashboard system allows the user to create their favorite link to other web pages in the system, and add that link to the dashboard section of the system for easy one click navigation. This is shown as item 44 in FIG. 7.

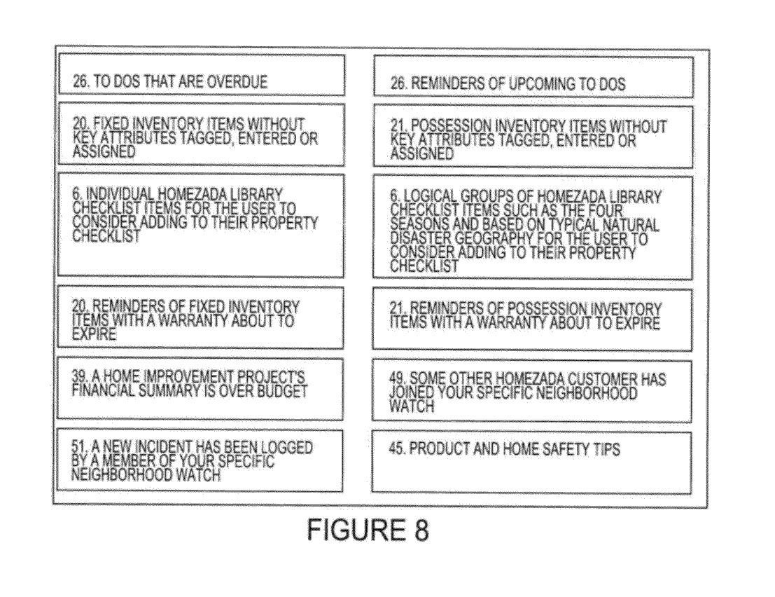

Another unique aspect of the system is the News and Alerts functionality shown in FIG. 8. This part of the system presents the user a number of different news and alert items that are specific to their properties. Many of these news items are generated from data populated in other parts of the system. Item 26 is a news type that is based on To Dos that have not been marked as complete and that have a current due date that has already elapsed, or is essentially before the current date. The news item allows the user to perform three actions, including marking the To Do as complete, snoozing the To Do to a different date, or Dismissing the news alert so as not to see it anymore. Item 26 also provides Reminder alerts for To Dos that are not complete, and that the due date is upcoming in the next few days.

Item 20 shows the user news items based on their fixed inventory items that do not have photos attached, owner's manuals attached or linked, or warranties about to expire. Item 21 shows the user news items based on their possession inventory items that do not have photos attached, or purchase dates and prices, or owner's manuals attached or linked, or warranties about to expire. These news items provide statistics to the user to help them build their inventory property profile.

Item 6 in FIG. 8 are news items that show the user either individual suggestions from the HomeZada library of best practice routines, or even groups of multiple checklist items that are grouped by the four seasons of the year, or by typical natural disasters based on the properties geographical location. The user is encouraged to view these suggestions and then add them to their property checklist if they would like.

Item 39 is a news item that shows the user for any projects that are in progress where the total value of the commitment items is greater than the established budget for those items. Item 45 shows the user various tips on products to use in cleaning and maintain a property as well as general safety practices for keeping a property safe.

It 49 is an alert that comes to the user when another HomeZada user has joined their virtual neighborhood watch. Item 51 is an alert that comes to the user when any neighbor who belongs to their virtual neighborhood watch has posted an incident.

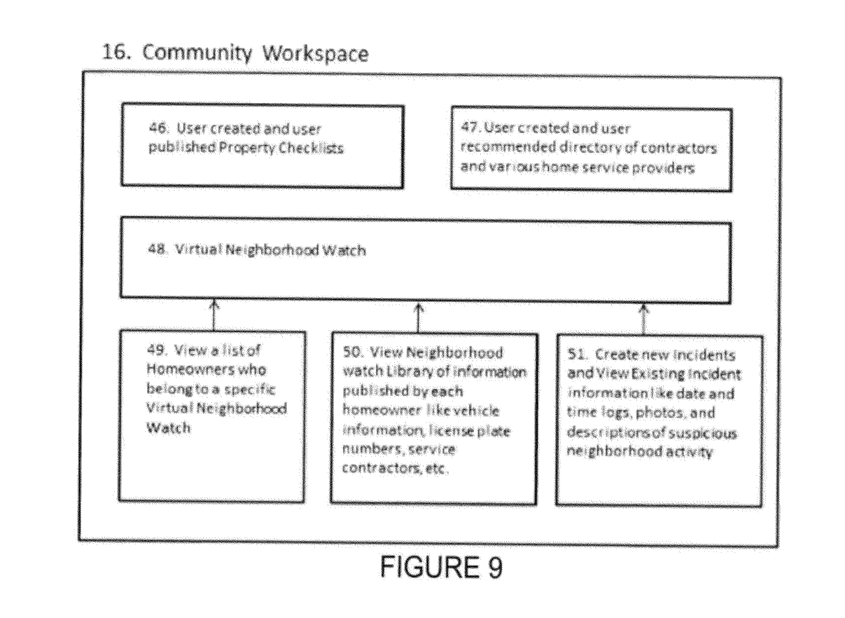

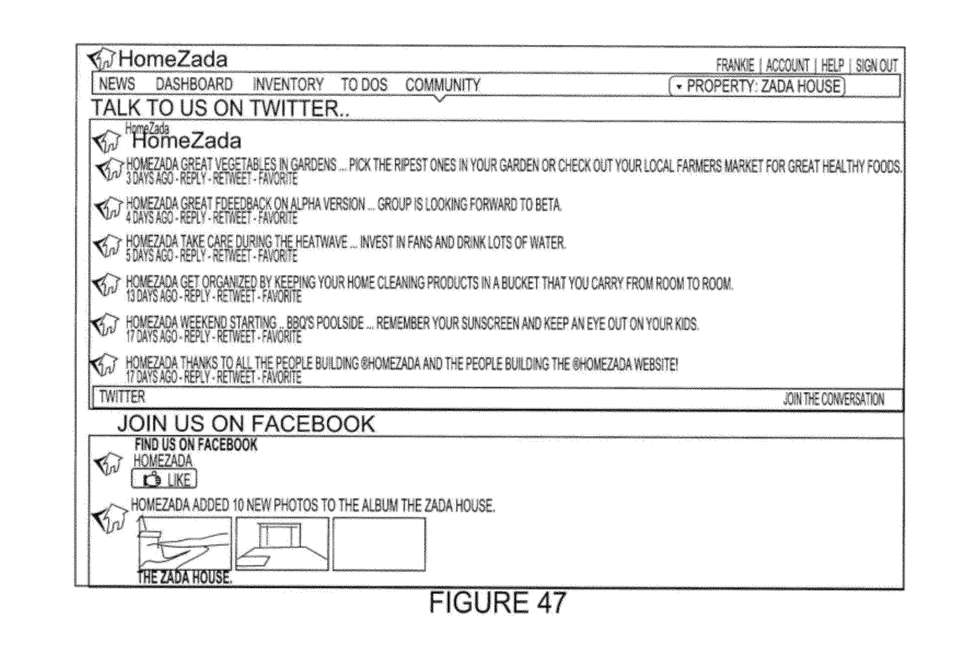

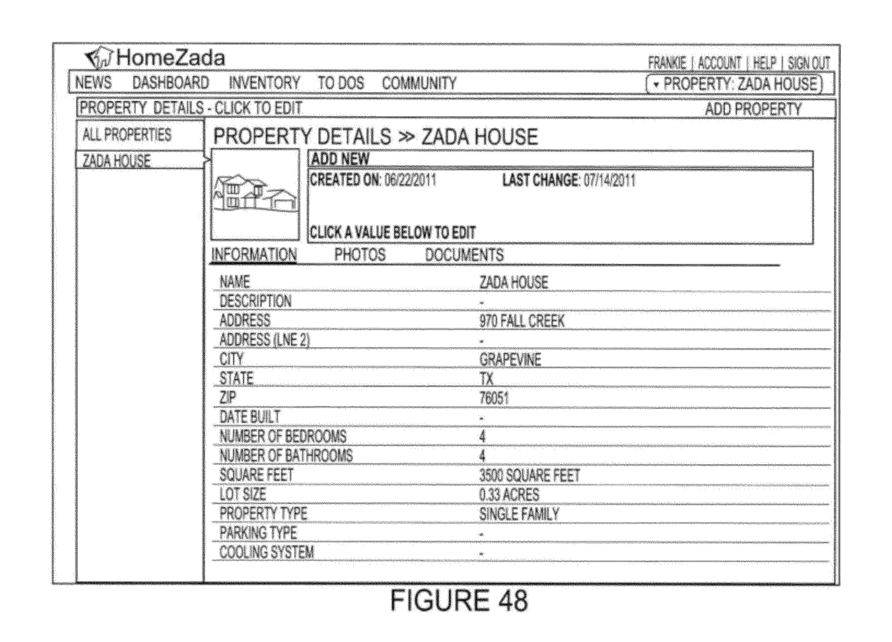

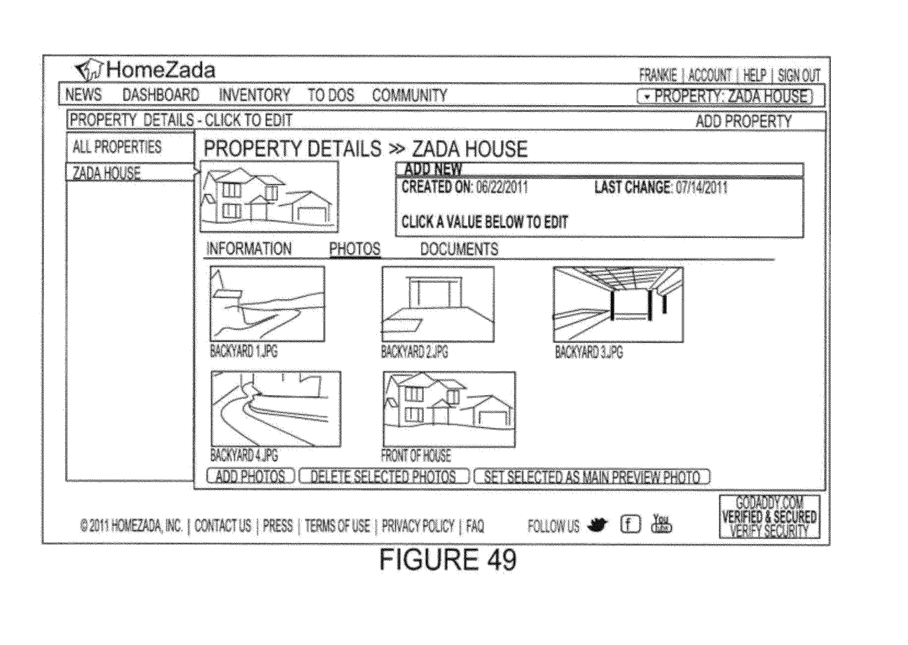

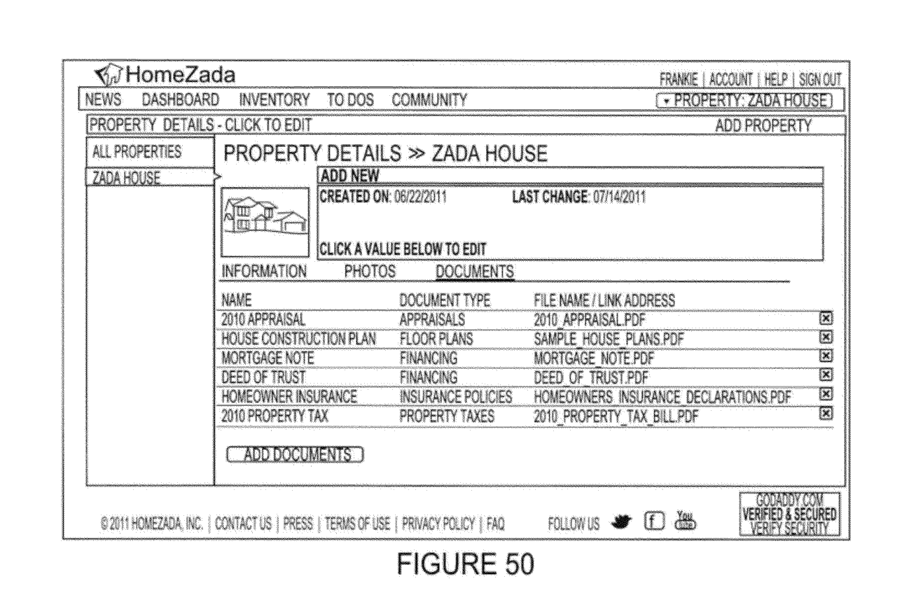

The Community workspace is where a customer can participate in community functionality that is open to all HomeZada users where the information is not specific to their property. The Community Workspace functionality is shown in FIG. 9. An example of the community user interface of the system in shown in FIG. 47. Item 46 is where users who created their own unique Property Checklists have chosen to publish those to the community and thus any HomeZada customer can view all of the community published property checklists. Item 47 is an area of the Community where users can published their own list of home service providers so that others in the community can view those same vendors.

Item 48 is where the user can either create a new Virtual Neighborhood Watch or join an existing one. A virtual neighborhood watch is a collection of HomeZada users who have agreed to come together online within a specific distance from their respective homes. Item 49 allows each HomeZada customer to view a map of their neighborhood to see who else is also a HomeZada customer. Item 50 is where each customer who is also a member of a specific neighborhood watch can publish common information such as vehicle descriptions, license plates and commonly used service providers. The user can also view all other members of that specific neighborhood watch's information as a common library amongst the neighborhood. Item 51 is where any member of the neighborhood watch can post a new incident or view existing incidents. Each incident can have uploaded photos along with important specifics such as the date, time, and specific location and description of the incident. This allows members of the watch to record any suspicious activities around not only their home, but within their neighborhood.

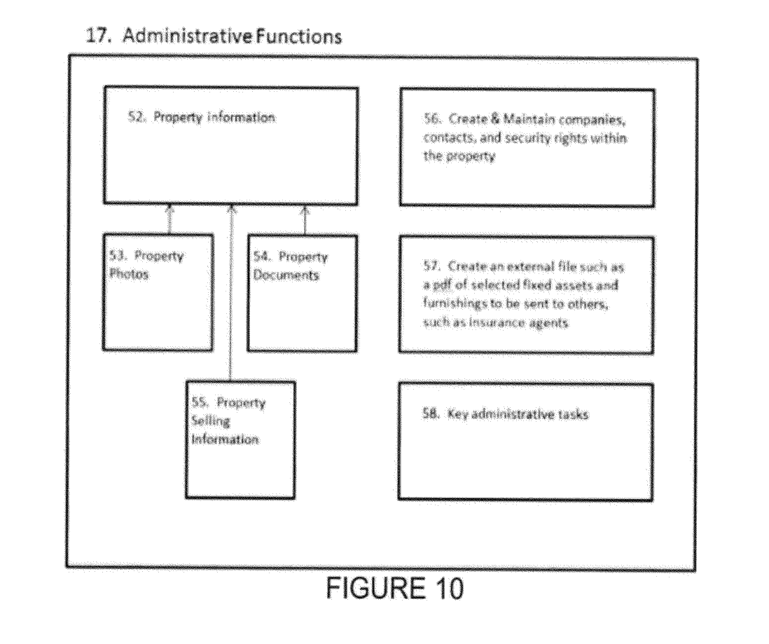

Another key aspect of the system is managing administrative functions as show in FIG. 10. Here the user provides various descriptive attributes about the property as shown in item 52. These items are the address, the size of home and property, the type of home, the location of the property and various property tax information attributes. The user can also create multiple properties from here for vacation property, rental property or even property that they may be managing for an elderly parent. In Item 53, the user can upload and view photos of the overall property as well as in Item 54, the user can upload and view multiple documents about the home such as appraisals, deeds of trust, mortgage documents, design and construction floor plans, homeowner's insurance policies and any other documents the user wishes to upload to the system. Item 55 is where the user can enter in information when they want to sell their property and make their property public on the free HomeZada marketing pages. The information they can put here include their real estate broker and agent's name and contact information, as well as links to other multiple listing services.

The user can also enter all of their contacts of other family members and third party contractors as a directory for people and companies associated with the properties. The user can also create logins for people in the property directory, and assign them the appropriate security rights. This functionality is shown as Item 56.

Item 57 is where the system provides the ability for the user execute a multi step wizard in order to select inventory and to select which photos to include in the creation of a file that can be sent to an insurance agent documenting inventory within a property, and their current condition as evidenced by a digital photo. Item 58 is an area of the system where the user can execute three actions. The first action is the process of making their property in the system public, which allows people to see their property online with the associated inventory and photos. The second key action is where the account owner can transfer the property back to the property asset system, which is primarily done when the account owner has sold their property and they want to provide an electronic record of the property and its inventory to the new buyer.

The third key action is when an account owner has purchased a new property, and they want to know to import the inventory and their associated photos as part of their account.

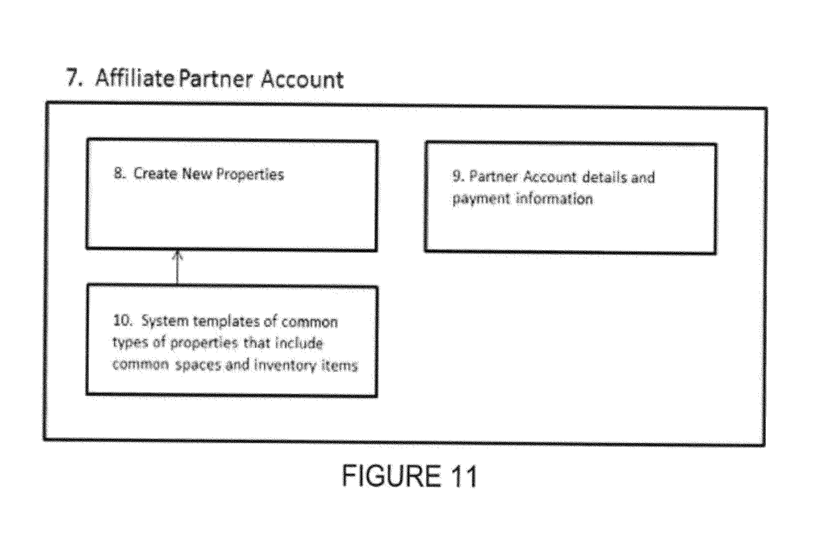

FIG. 11 depicts the functionality for HomeZada to provide Affiliated Partners their own access to the overall system. Partners who comply with various business terms with HomeZada can have a partner account established. Once the partner account is established, the Partner can login to the system via their partner account. Item 8 allows the partner to create multiple new properties by choosing from the same set of templates as indicated in Item 10. The Partner can also maintain their account and payment details as shown in Item 9.

Key Actions in the System

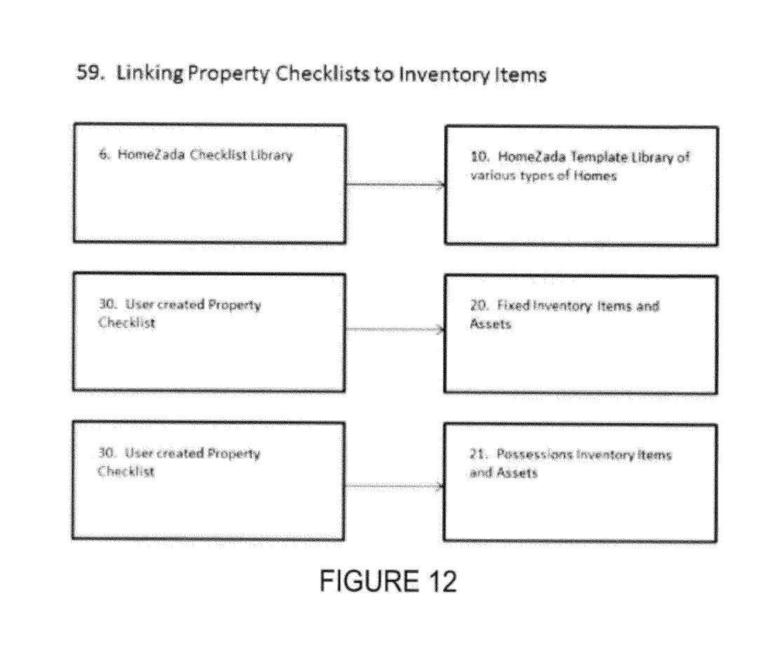

HomeZada has a unique way of linking a Home Property Checklists to Home Inventory Items. HomeZada does this linking in three different ways as illustrated in FIG. 12. The first method of linking is with Item 6, which is HomeZada's Checklist library of over 150 best practice routines for cleaning the house, maintaining equipment and materials in the house, and the outside lawn, garden and other yardwork checklists. These checklist items are already linked to the various templates the HomeZada provides the user when the create a new property. This is depicted in Item 10. As an example, a checklist item in Item 6 states that a home owner should change the air filters in their air conditioning and heating system four times a year. This checklist is already linked to every HomeZada template in Item 10 where each house has a furnace and air conditioning unit.

In the second row in FIG. 12, the user can create their own property checklist as indicated in Item 30. On this checklist, they can link this checklist to any Fixed Inventory Item in their properties account as shown in Item 20. In addition, with the third row in FIG. 12, they can also link any property checklist to any Possession Inventory Item in the properties account, as shown in Item 21. These features maintain an important link between the maintenance of the property and all the spaces and inventory items within the property.

HomeZada also has a unique way of linking its Home Improvement Projects to the property Inventory. This functionality is important because when a home owner remodels their home, they are often times buying new materials and equipment as part of the project processes, that ultimately needs to be accounted for as the home's updated inventory items.

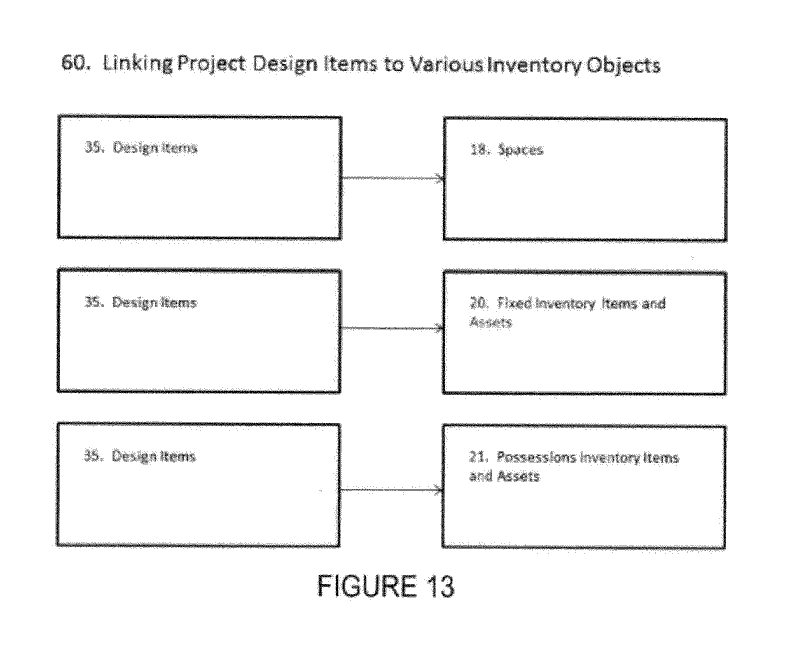

Within a HomeZada project are a series of Design Items. These items are essentially the bill of materials that need to be purchased for the home improvement project. As an example, a project could be a Kitchen remodel with multiple design items, such as a new refrigerator, a new stove, new cabinets, new flooring and new countertops. The user can use HomeZada's design items to track all the items that need to be purchased for this Kitchen remodel. Once the remodel is complete, those design items have been installed in the kitchen and the user should update their inventory for insurance purposes. HomeZada does that automatically by giving the user the ability to link and create new Spaces, Fixed Inventory Items or Possession Inventory Items from the design items. This functionality is shown in each of the three rows in FIG. 13.

The property asset system has an affiliate partner program that allows third party companies who comply with the property asset system's business terms to create home inventory on behalf of their customers. This allows people who don't want to create a home inventory record themselves within The property asset system to hire an authorized third party to do it for them.

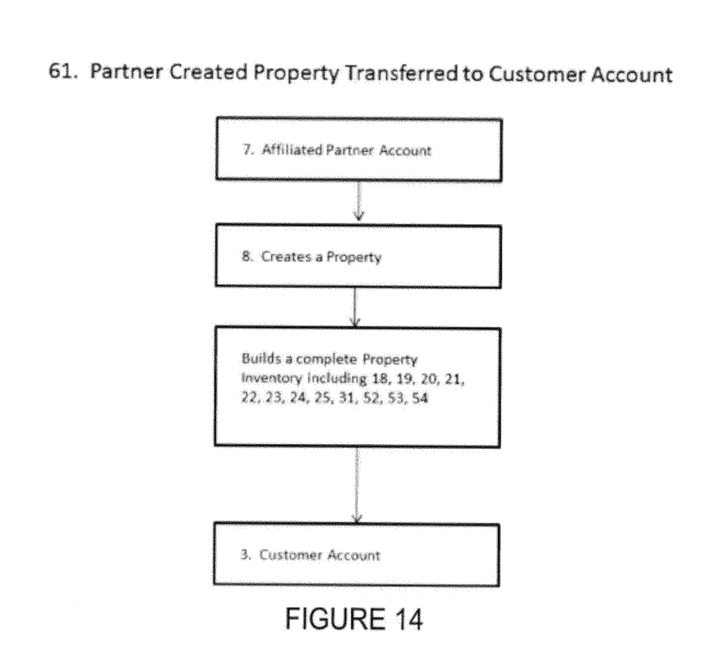

FIG. 14 illustrates the sequence of events in this process. Once a partner is authorized, they login to the property asset system with their affiliated partner account information, as shown in Item 7. Once they do this, they can create a new property for their home owner client who has hired them to create a home inventory. Once the partner creates the specific property, they can then build the detailed profile of a home's inventory including all the Spaces (18), Photos of Spaces (19), Fixed Inventory Items and Assets (20), Possession Inventory Items and Assets (21), Photos of all the Inventory Items (22), Documents such as owner's manuals of the Inventory Items (23), Setup the Controls Interface (24), setup the To Do History (25), the property asset system created Property Checklists (35), detailed Property Information (52), Property Photos (53), and Property Documents (54).

Once they have completed these items they transfer the property and all the detailed items to the customer, who now can view and manage all the home inventory through their customer account. The sequence of events is depicted in FIG. 14 below.

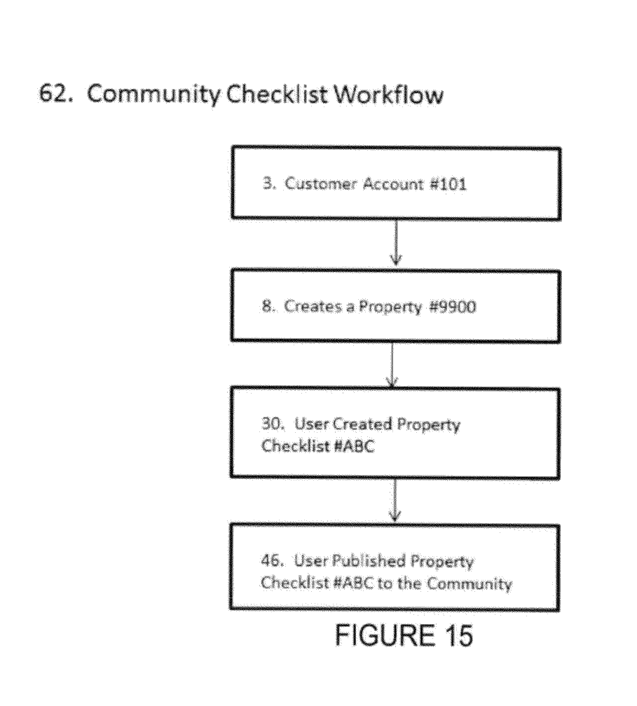

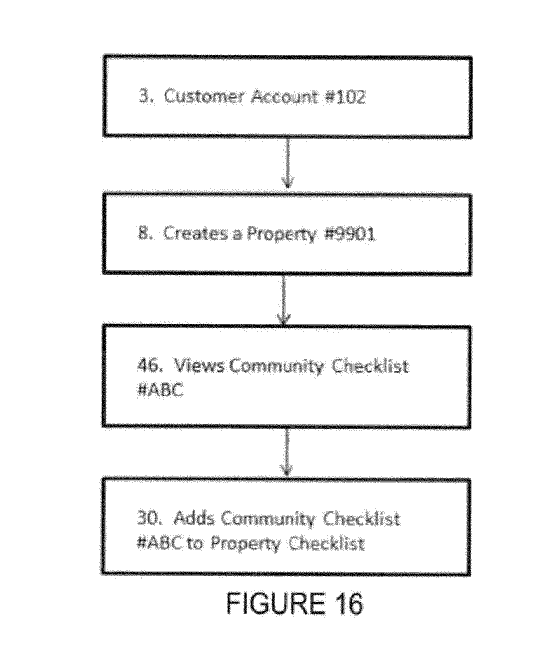

The property asset system has a unique feature of sharing user authored property checklists within the entire property asset system community. Since home owner's across the country live in dramatically different areas regarding climate and natural disasters, as well as living in homes with a large degree of age difference and thus the level of sophistication in the equipment and building materials depending on the age of the home, the property asset system has create a crowd sourcing ability for one property asset system customers to share their best practices with the entire community of property asset system customers. This process is shown in FIG. 15 and FIG. 16.

In FIG. 15, as an example, a unique property asset system customer with the ID number of 101, creates a property with a unique property ID of 9900. Customer 101 can now go to the Property Checklist feature in the property asset system, as shown in Item 30 in FIG. 15, and create a unique property checklist about maintaining a septic tank, as an example. This user created septic tank has an internal ID of ABC. Customer 101 now wishes to participate in the property asset system Community so he decides to publish his property checklist ABC, which is about septic tanks, and how best practice says you should check it twice a year.

Now to further this example, a different customer with a unique ID of 102 creates and account and creates their property with the unique ID of 9901, as illustrated in Item 3 and 8 in FIG. 16. Now Customer 102 goes to navigate to the Community portion of the property asset system application, and search for all the user authored property checklists that have been published to the community. Customer 102 search for septic tank, and they can now view Community Checklist ABC that was authored by Customer 101. Customer 102 like this property checklist, and adds it to their specific property checklist within their property which is 9901. Customer 102 can now assign the responsibility for this checklist within their property, and the property asset system will automatically create appropriate To Dos for Customer 102 on their To Do List and To Do Calendar. The process for Customer 102 is shown in FIG. 16.

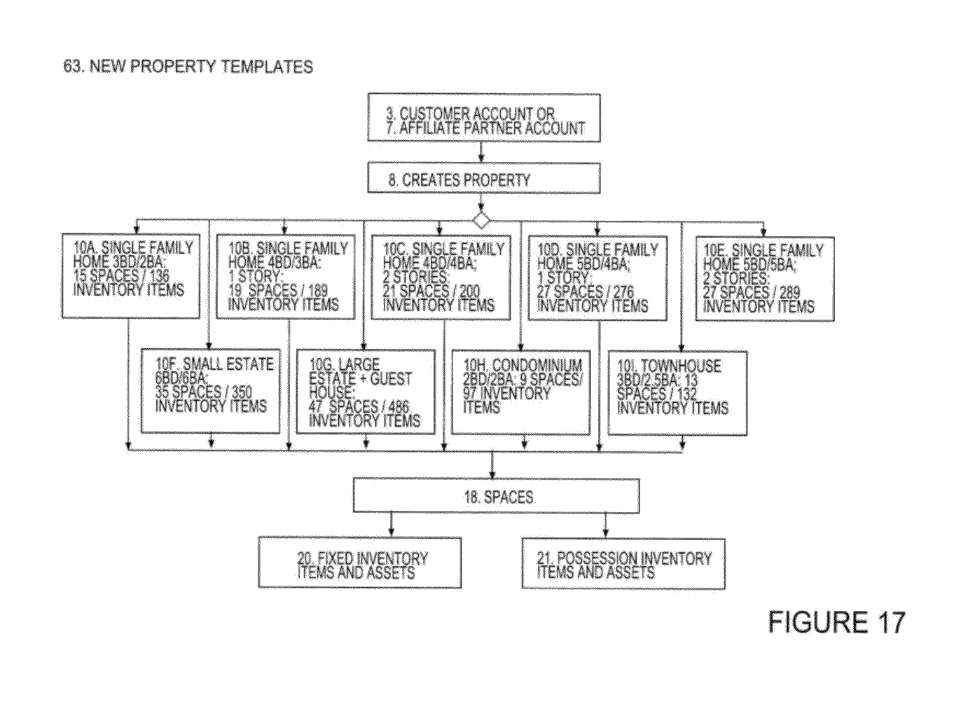

The property asset system has a number of unique property templates that the system selects from when the user creates a new property. This system of templates is unique because it pre-populates a home with various Spaces, Fixed and Possession Inventory Items so the user does not have to enter a lot of their inventory items manually. All they have to do is edit the prepopulated template to adjust the Spaces and the Inventory Items to match their property. This is far less time consuming and far less manual data entry than if they user had to type in every Space and Inventory Item from scratch. The process of these templates and the details of how they work is shown in FIG. 17.

Once the customer or even partner has a valid account, they can create a property. During the property creation process, the user is asked to select a property type such as a single family home, an estate, a condominium, or a townhouse. The user is also asked to select the number of bedrooms and bathrooms in their property. The combination of these data inputs from the user directs the property asset system to use one of the 9 templates, as shown in FIG. 17 as Items 10A through 10I. Each one of these 9 templates has been developed by the property asset system with a specific number of Spaces and Inventory Items, (both Fixed and Possession types).

Smaller homes have fewer spaces and fewer inventory items, while larger homes have more spaces and more inventory items.

Once the user's specific property is created with the corresponding template of Spaces and Inventory Items, the user can view all the prepopulated data from the template and begin editing it by navigating to the Spaces and editing to match their home, as shown in Item 18. The user can also edit all the Fixed and Possession Inventory Items by easily deleting ones that the user does not have, and quickly adding items the user does have but was including in the template that was chosen, as shown in Items 20 and 21 in FIG. 17.

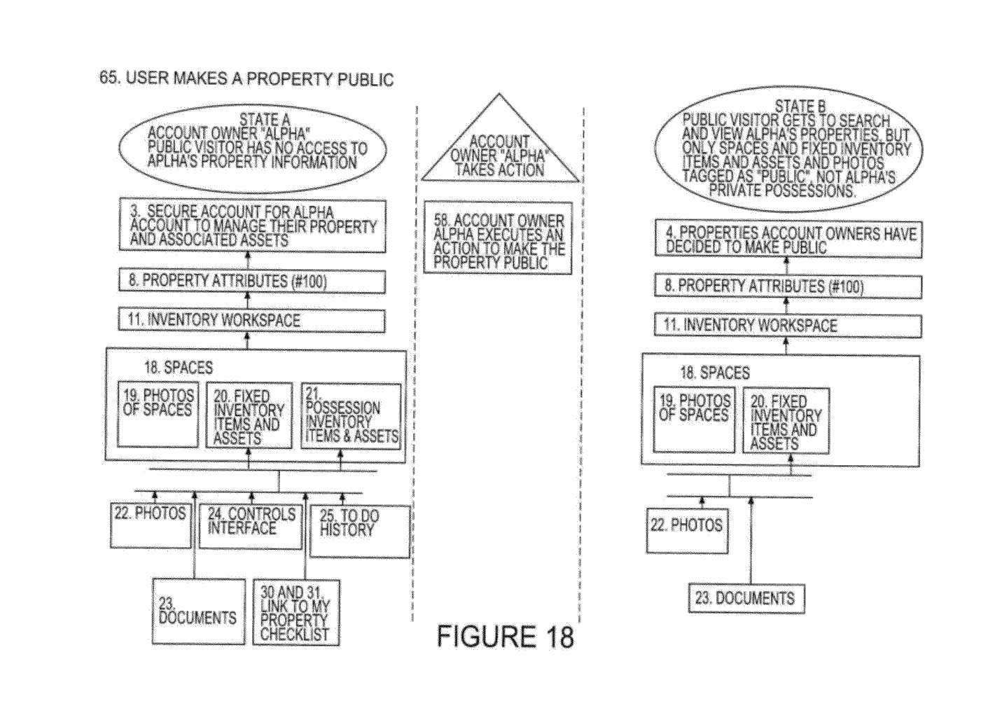

Another key process in the property asset system is depicted in FIG. 18. The context behind this process is an account owner is using the property asset system to manage their property and the associated inventory, to dos, projects, etc. The account owner and the system are maintaining this information in a secure and private context, where only the account owner has access to the property information via a unique and secure login into the system. In FIG. 18, the column labeled State A is illustrating the structure of the system when the account owner and the property asset system are maintaining the property in a secure and private manner.

In FIG. 18, State A is where a sample account owner called Alpha is managing their property with the property asset system. The FIGURE continues to illustrate the structure of the system, with item 3 being the secure aspect of Alpha's account and item 8 being the property that Alpha is managing, which by way of sample is identified as Property #100. Item 11 is the Inventory part of the system, followed by Item 18 which is a hierarchical view of the two different kinds of inventory, with item 18 being Spaces within the property, item 20 being the fixed inventory items, and item 21 being the possession inventory items. The diagram continues deeper in the structure by showing item 22 for photos and videos, item 23 for the documents, item 24 the asset control interface, item 25 the to do history, and item 30 and 31 linked to the property checklist.

The next step in the process is where the account owner Alpha, decides that they want to sell their current property, and therefore Alpha would like to make a portion of the properties information available to the public on the interne. This is illustrated in the middle column of FIG. 18, where Alpha goes to item 58 of the property asset system and executes an action to make their Property #100 public. Once this happens, the property asset system makes a portion of Alpha' Property #100 available to be viewed by public users of the internet, while still maintaining the whole system available to Alpha's private and personal use.

State B of FIG. 18 illustrates what a public user of the property asset system has available to them to view, after the individual action of Alpha account owner. Item 4 shows that public users access properties on the property asset system that account owners have decided to make public. Further drilling down into the structure, Property #100 and its attributes are viewable to public users as shown in item 8. Item 11 makes the inventory of Property #100 available for viewing, as well as the Spaces in item 18. A key difference between State A and State B is that State B only includes the spaces and fixed inventory items as show by item 18 and item 20. This allows Alpha owner to keep their personal possession inventory items private and not exposed to the public, yet expose those spaces and the fixed inventory items to prospective buyers of their property. In addition, in State B, only those photos and videos that Alpha has tagged as being available to the public is shown in item 22 and only those documents that Alpha has tagged as being available to the public is shown in item 25. This action also keeps item 24, the controls interface, and item 25, the to do history, private for Alpha's personal use, and does not expose this functionality to the public user in State B.

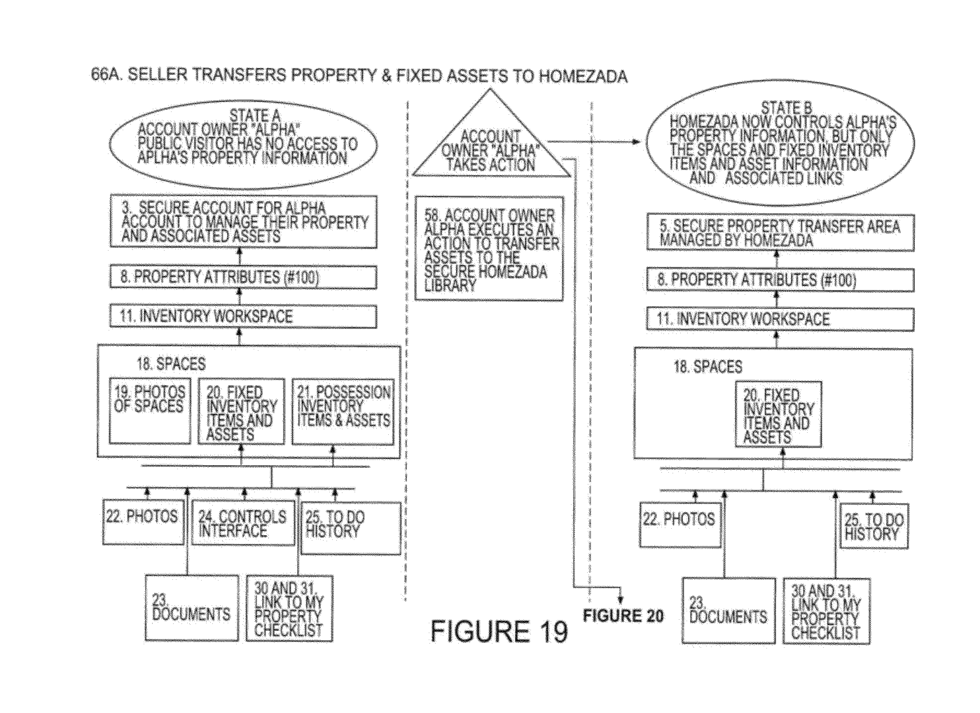

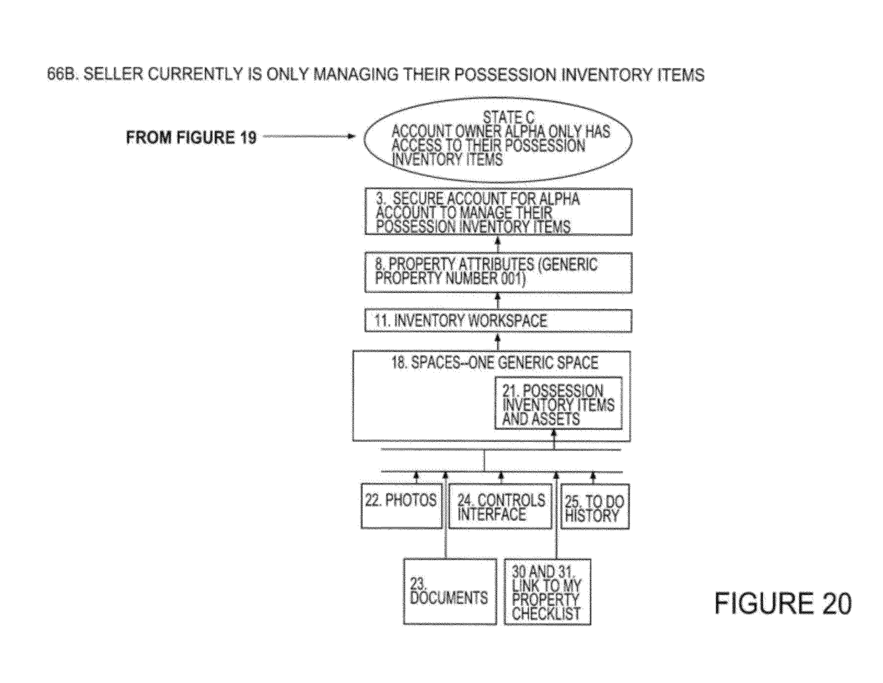

Another unique process of the property asset system is shown in FIG. 19 and FIG. 20. The overall concept of this process is one where a current owner of a property sells the property, and in doing so, transfers the information about their property and specific inventory back to the property asset system, so that this electronic record of the property and its fixed inventory items are available for the new owner to inherit to maintain the upkeep of the property and its fixed inventory items.

In State A, the account owner Alpha, is securely and privately maintaining their property as shown with item 3 and item 8. In addition, Alpha is managing their inventory as shown in items 11, 18, 19, 20 and 21. Linked to those inventory items are item 22, 23, 24, 25 and 30 and 31 which are photos, documents, control interface, to do history, and links to property checklists.

The middle column of FIG. 10 shows that the Alpha account owner goes to Item 58 in the system to execute an action that results in State B shown in FIG. 19 and State C shown in FIG. 20. State B is where Property #100 transfers from item 3 to item 5, which is a secure area that the property asset system securely holds the property. In addition, State B includes inventory in item 11, 18, and 20. This means that the properties spaces and fixed inventory items are now in control by the property asset system, as well as the user tagged photos and documents and the to do history, shown as item 22, 23, and 25 in the third column of FIG. 19.

The other key part of this process is that Alpha account owner after the action was executed is now left with what is shown in FIG. 20, as State C. In State C, the Alpha account owner still has a secure and private account as shown in item 3. Alpha still has a property, but instead of the original property #100 that they had before that property was transferred to HomeZada, they now have a generic property as a shell. This generic property is now managing just Alpha's possession inventory which is shown as item 11, 18 with one generic space, and 21, because the spaces and fixed inventory items have been transferred to HomeZada as shown in FIG. 19, State B.

Alpha account is still managing the associated photos, documents, controls interface, to do history, and property checklist links that is linked to the possession inventory items, which is shown as item 22, 23, 24, 25, and 30 and 31 in State C of FIG. 20.

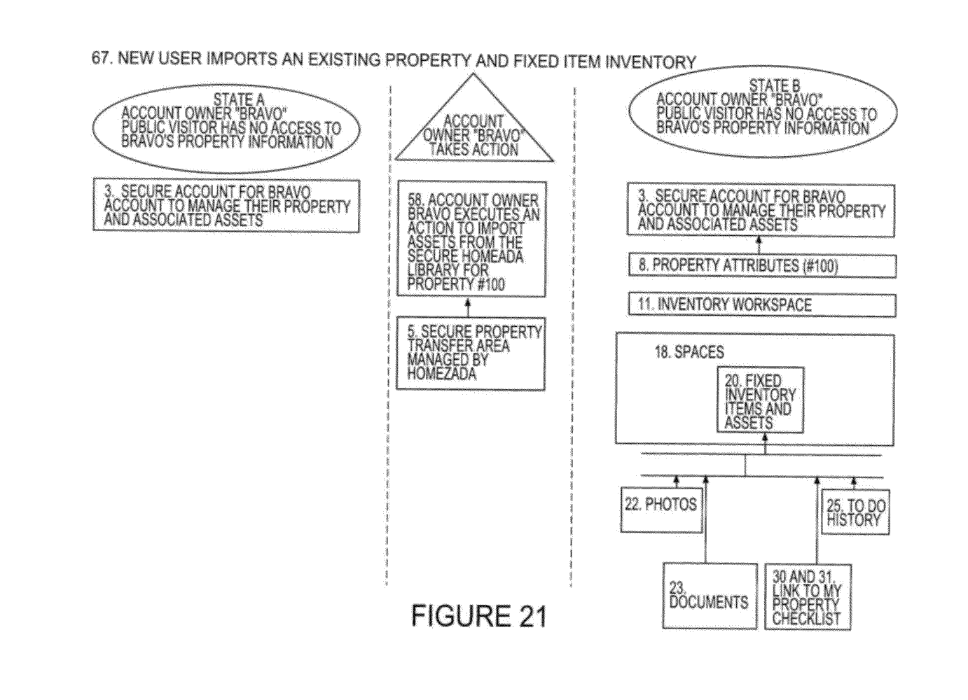

Another key process in the property asset system is shown in FIG. 21. The context of this process is where a buyer has bought an existing property and thus they have a generic property account in HomeZada, but then they want to gain access to the electronic records of the property they just purchased. This scenario is depicted as State A in FIG. 21, where a different account owner, Bravo, has a secure account as shown in item 3.

The next part of the process is shown in the middle column of FIG. 21, where the Bravo account owner goes to item 58 of the property asset system to import the property #100 that they just purchased, and that Alpha owner transfer to HomeZada in FIG. 10. The property is imported from Item 5, which is the secure property transfer area managed by HomeZada.

This action results in State B of FIG. 21. Bravo account owner still has a secure account, but their property is now the specific Property #100 that came from the property asset system. In addition, Bravo owner also now has all the spaces and fixed inventory items associated with Property #100 including any associated photos, documents, to do history, and links to property checklists. All of these items are show in State B as items 8, 11, 18, 20, 22, 23, 24, and 30 and 31.

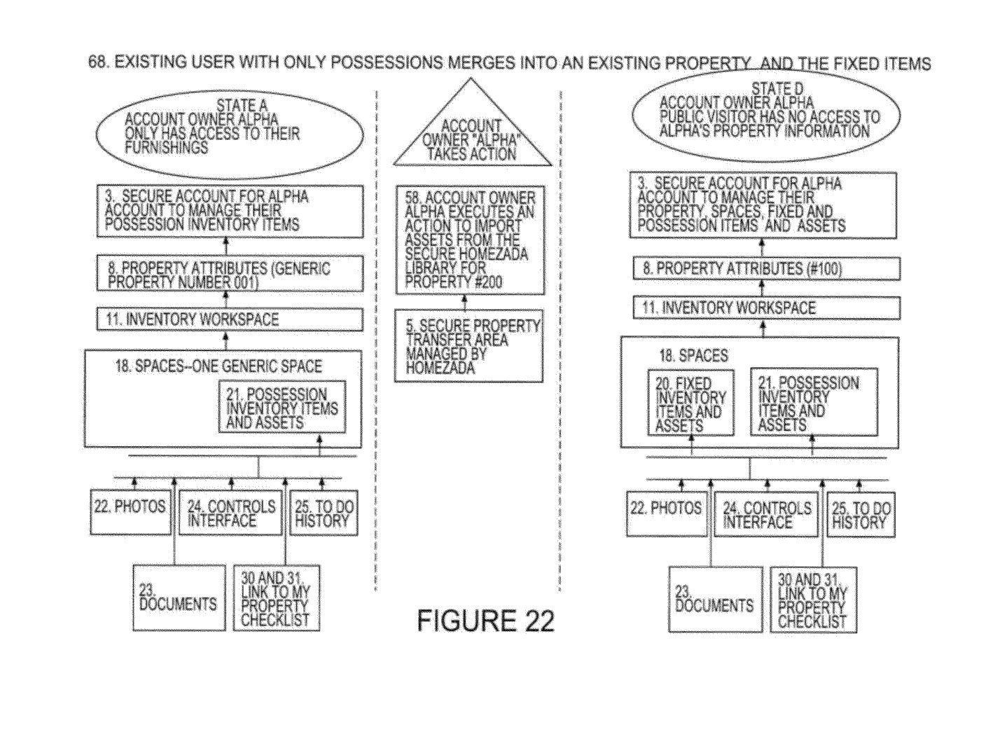

Another key process is the property asset system is illustrated in FIG. 22. In this process, an account owner has already transferred their existing property, and their account is managing their personal inventory as possession inventory. This account owner purchases an existing property, and then the system combines their personal possession inventory with the spaces and fixed inventory of the existing property.

State C of FIG. 22 shows the Alpha account owner with a secure account, the generic property number 001, their possession inventory, and the associated photos, documents, controls interfaces, to do history, and links to property checklists. This is shown as items 3, 8, 11, 18, 21, 22, 23, 24, 25, and 30 and 31.

The next step of the process is shown in the middle column of FIG. 22, where Alpha account owner goes to item 58 of the system and import Property #200 from the HomeZada-library of transferred properties, which is shown as item 5. The result of this action is shown as State D in the third column of FIG. 22.

In State D, the Alpha account owner still has a secure account and they now have Property #200 which is shown as item 3 and 8. The inventory and asset hierarchy of the system have now combined the possession inventory of Alpha account owner with the spaces and fixed inventory items of Property #200. This is shown as item 11, 18, 20, and 21. In addition, the system still provides the ability to manage photos, documents, controls interface, to do history, and property checklists which are shown as item 22, 23, 24, 25, and 30 and 31.

Mobile Applications for The Property Asset System

The property asset system comes with mobile applications that support the iPhone, Android, and Windows Mobile Phone 7 platforms. These mobile applications work in unison with the Web Application to provide home owners the ability to manage their home from a mobile smartphone.

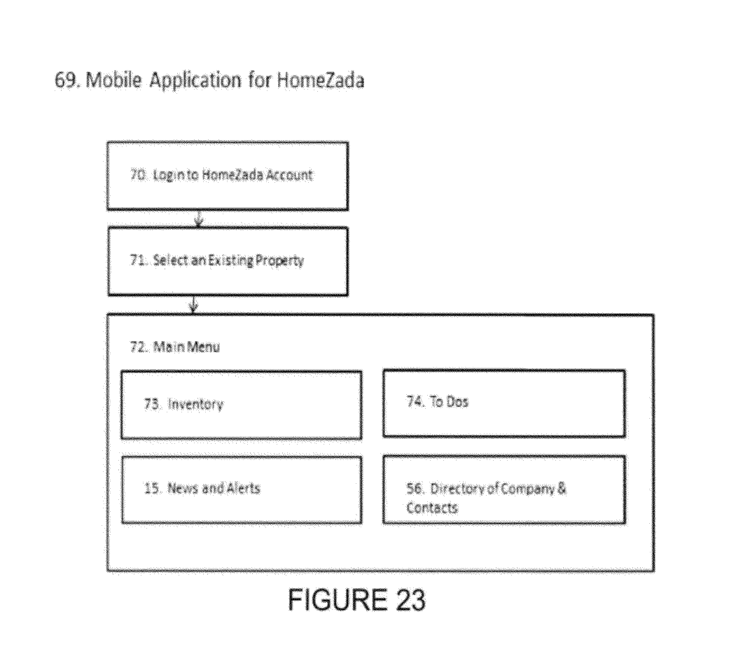

The overall design over how the property asset system mobile application works in shown in FIG. 23. Once the user installs the mobile application on their device, they can login to their property asset system account as long as they already have a valid property asset system account that they acquired via the web application. Once they login, the user selects a property from a list of properties that have already created in the web application. If the customers has more than one home, they can choose which home to view information on with the mobile application.

Once inside the application, the user can navigate to four main features in the mobile application that includes the inventory, the to dos, the news and alerts, as well as the directory of companies and contacts.

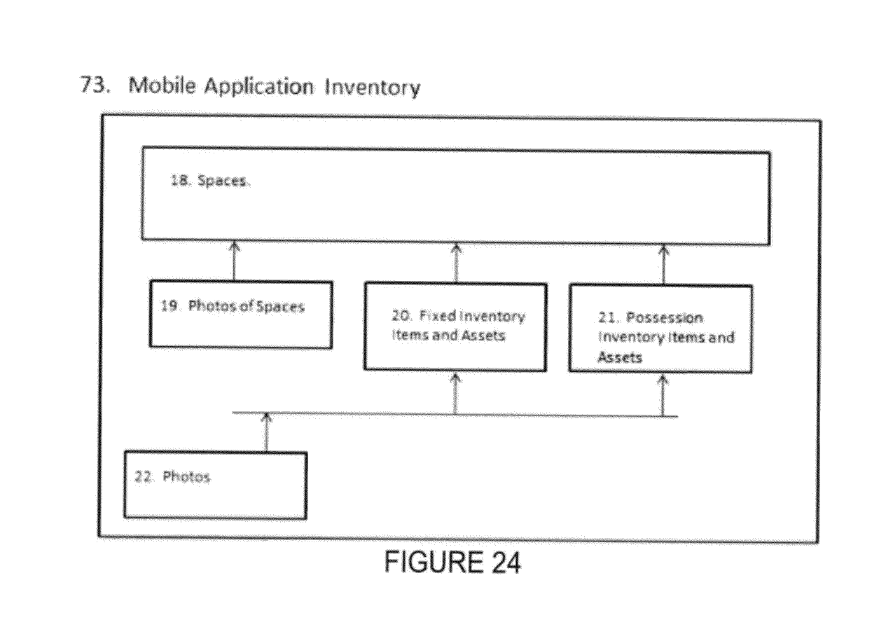

A key feature of the mobile application is the ability to perform a home inventory by using the mobile devices camera to take pictures and tag them to the appropriate space, fixed inventory item, or possession inventory item. Not only can they tag the photo to the appropriate inventory item, they can also enter basic inventory information such as the date purchased, the purchase price, the purchase location, the manufacturer of the item, and the specific model number. The functionality in the mobile application is shown in FIG. 24.

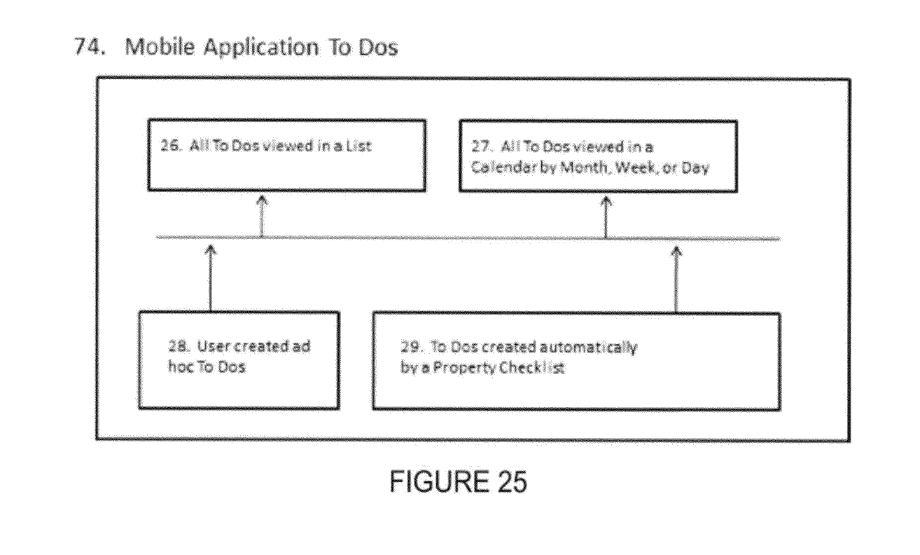

Another key feature of the mobile application is the To Do workspace. The user can view and edit all the to dos in both a list or table view as well as view the to dos in a calendar. The user can also create new ad hoc to dos in the mobile application. The functionality in the mobile application is shown in FIG. 25.

As shown in FIG. 23, the mobile application can also present the user all the same functionality of the news and alerts functionality in the web application shown in Item 15, as well as in FIG. 8. The mobile user can also view the complete directory of companies and contacts as shown in Item 56 of FIG. 23, which is the same functionality thee user has in the web application.

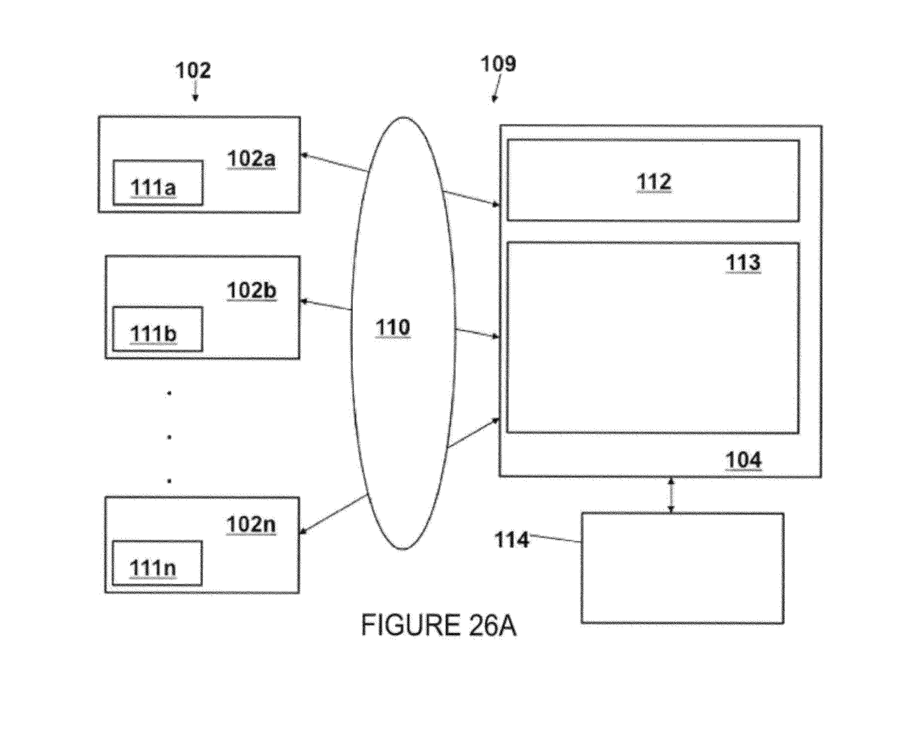

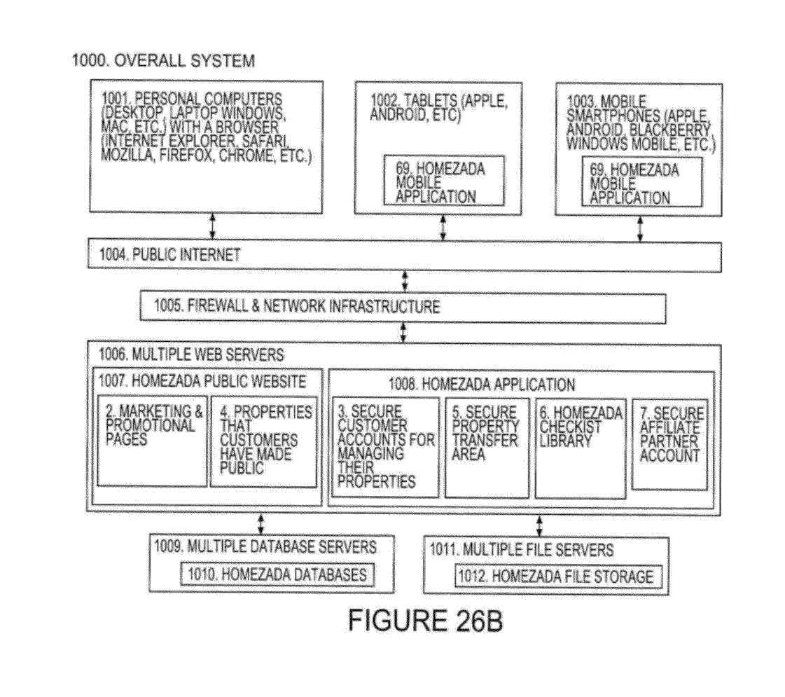

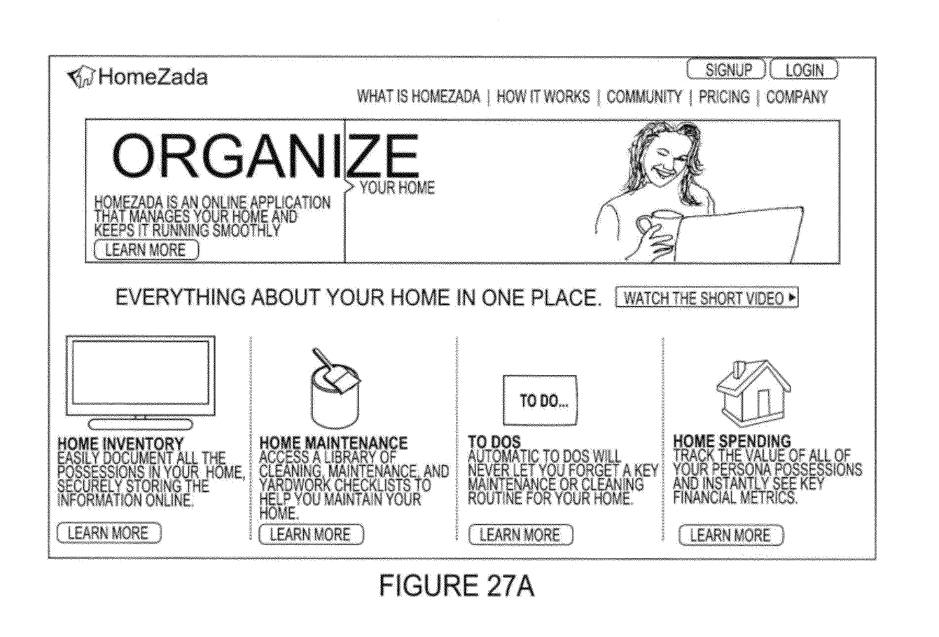

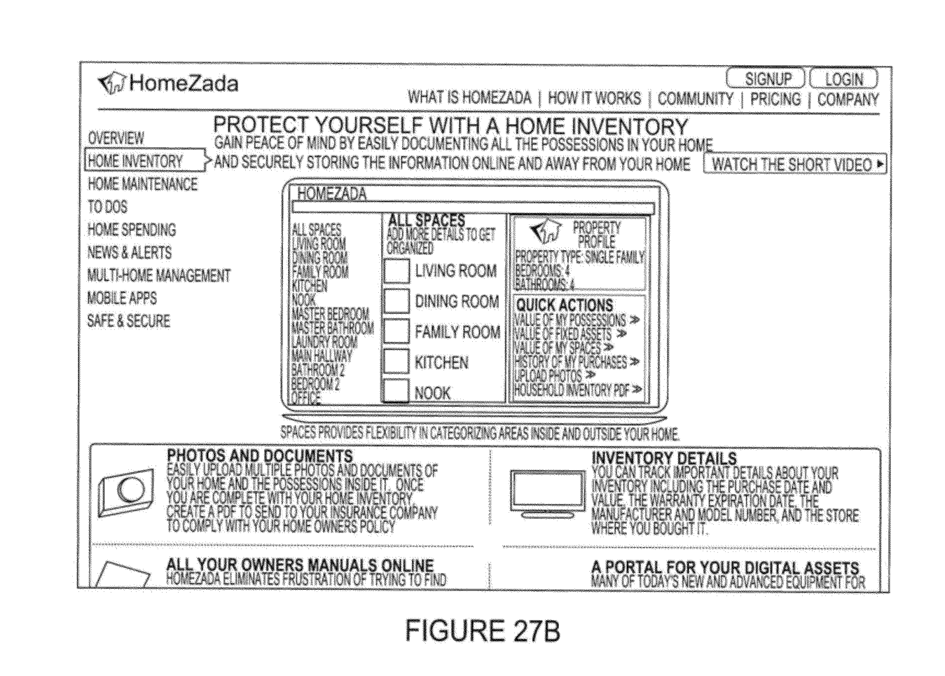

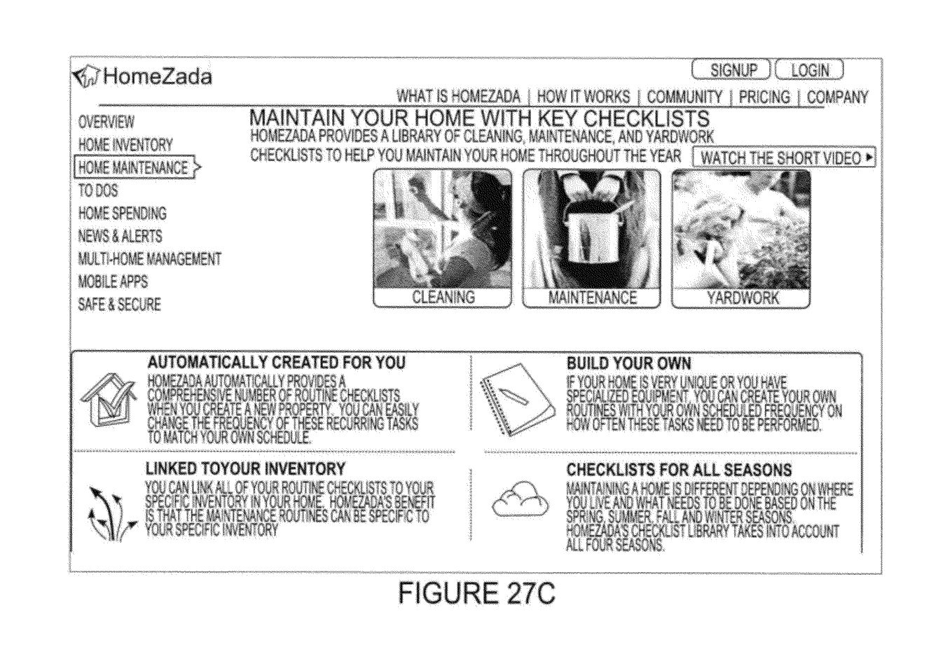

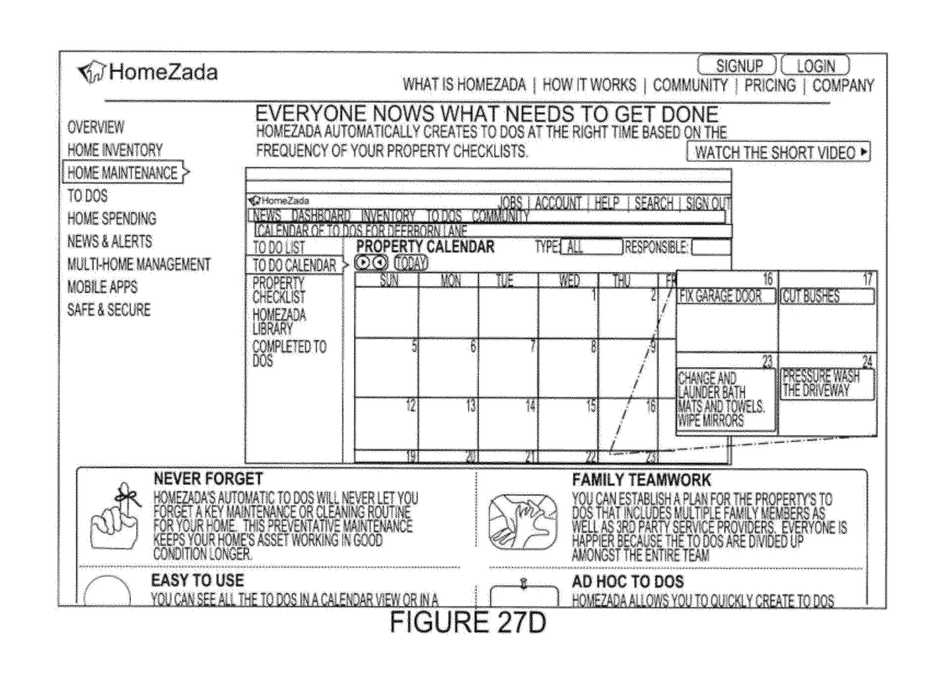

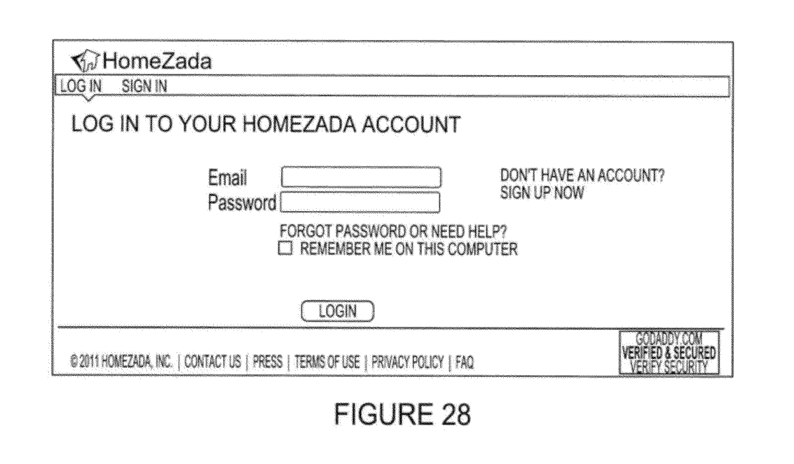

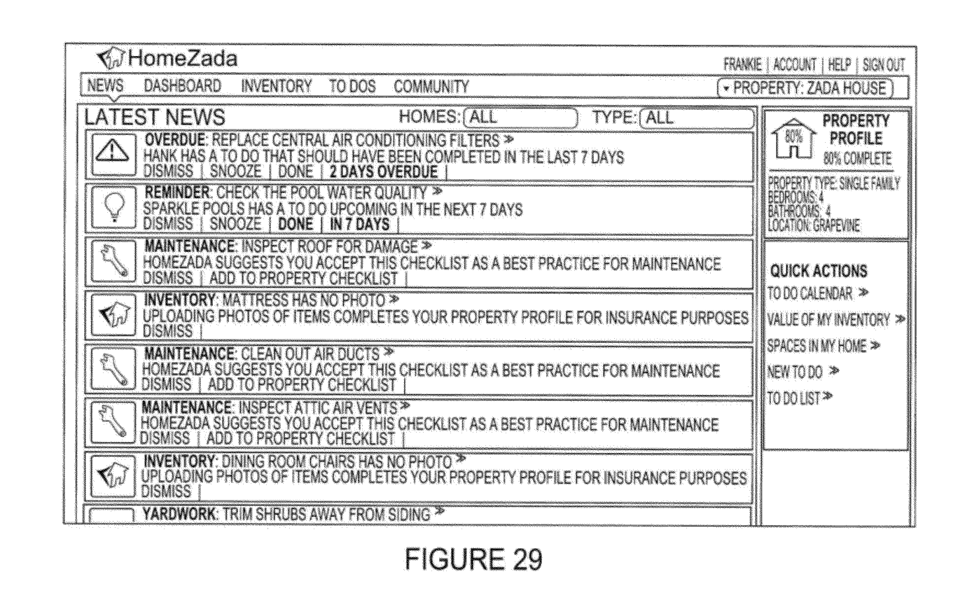

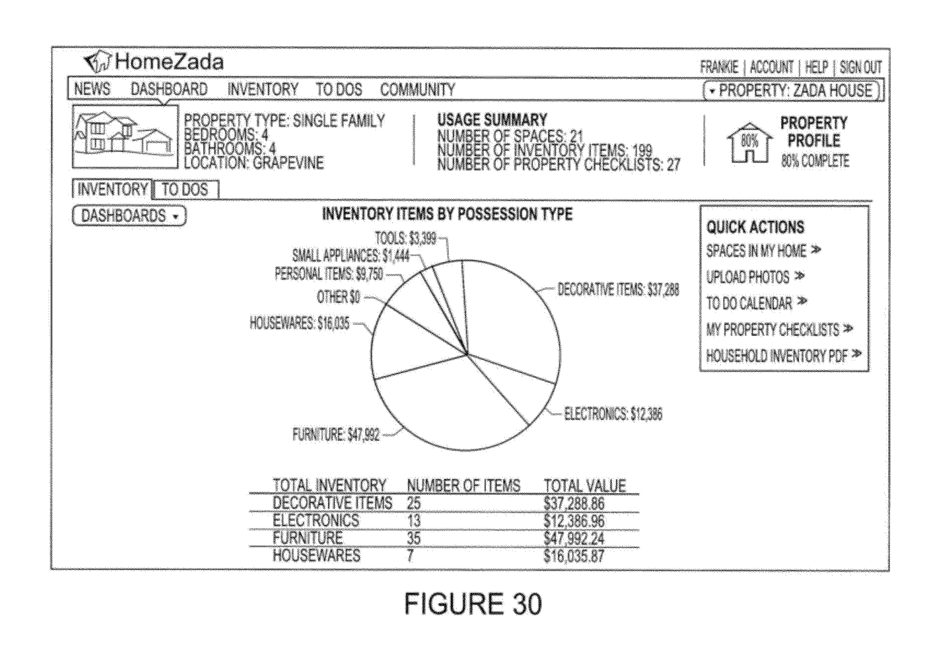

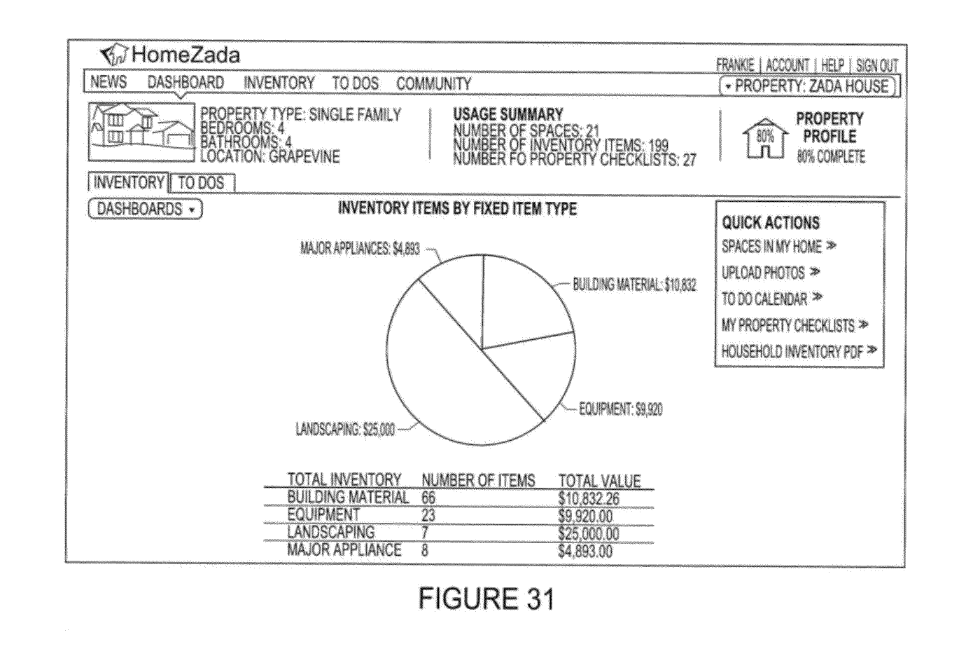

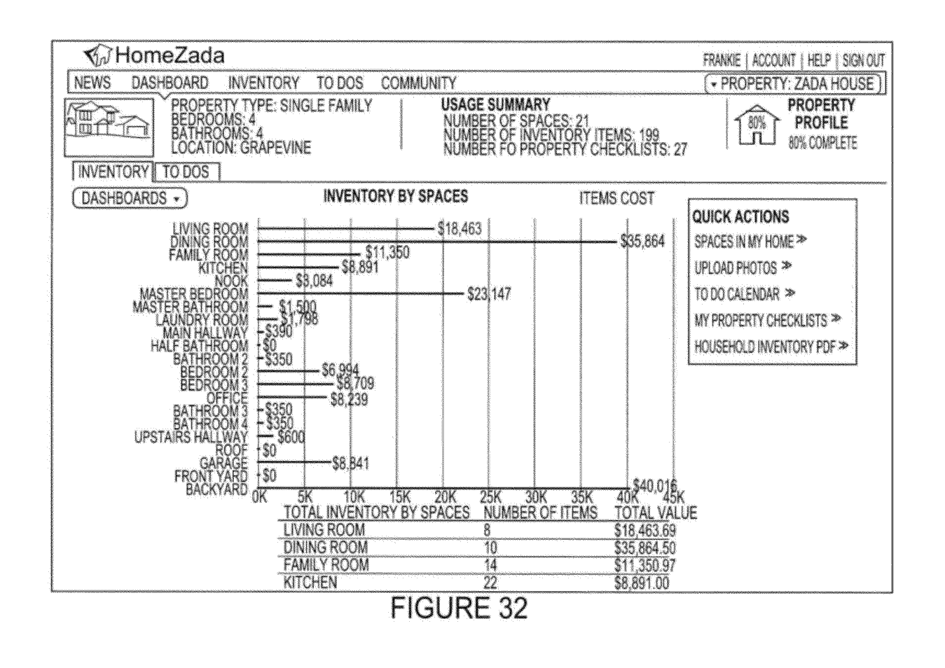

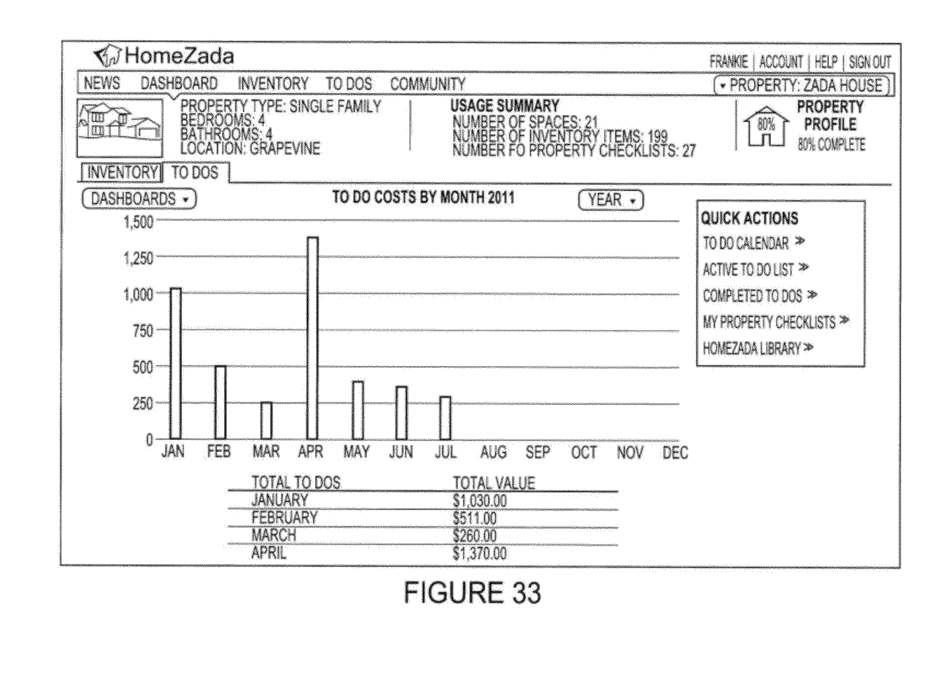

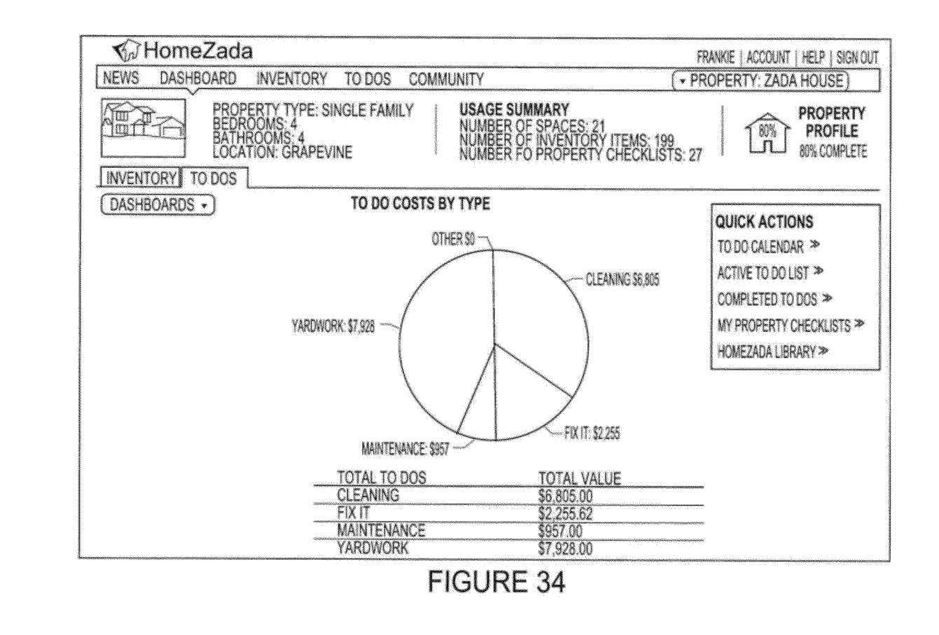

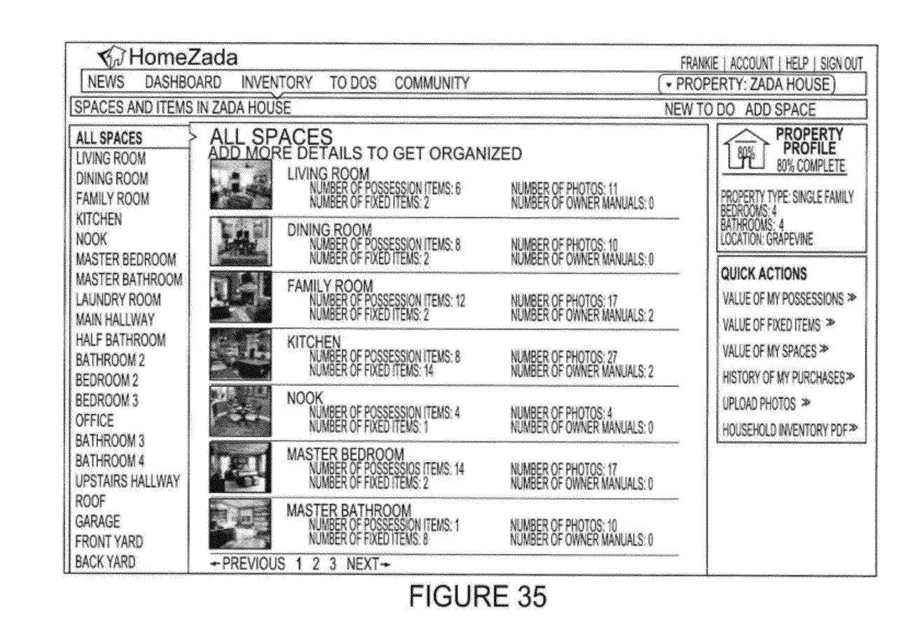

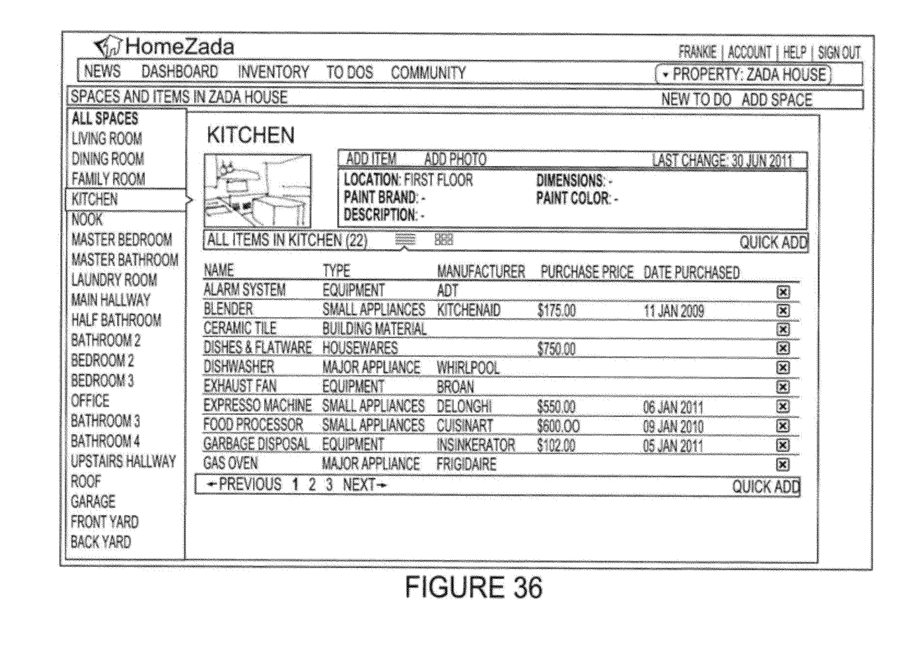

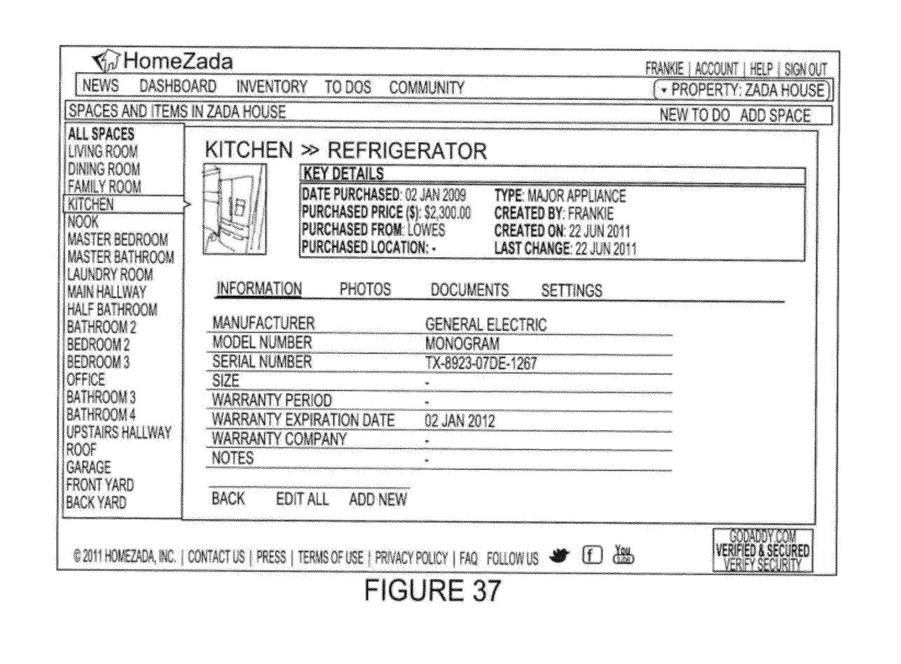

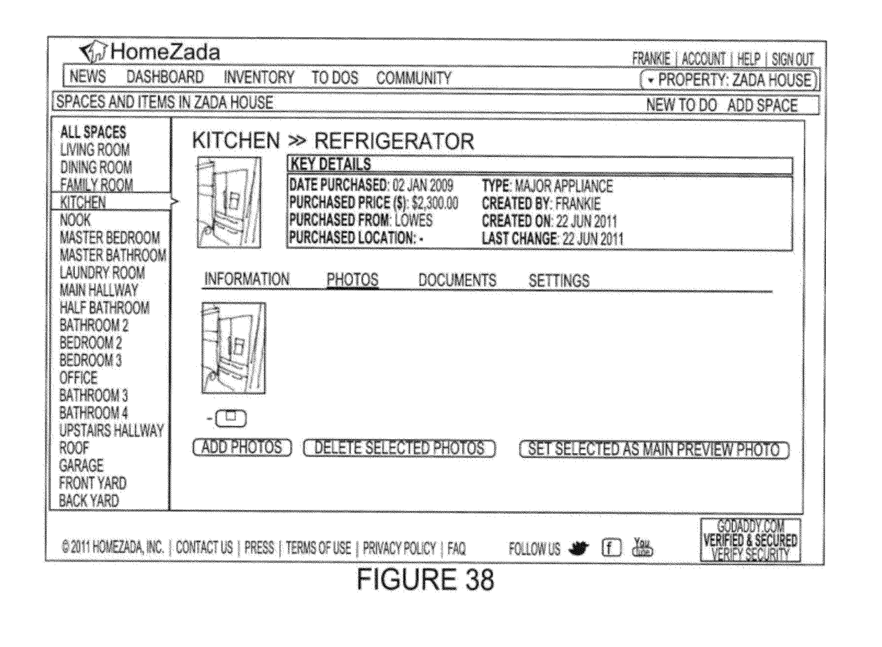

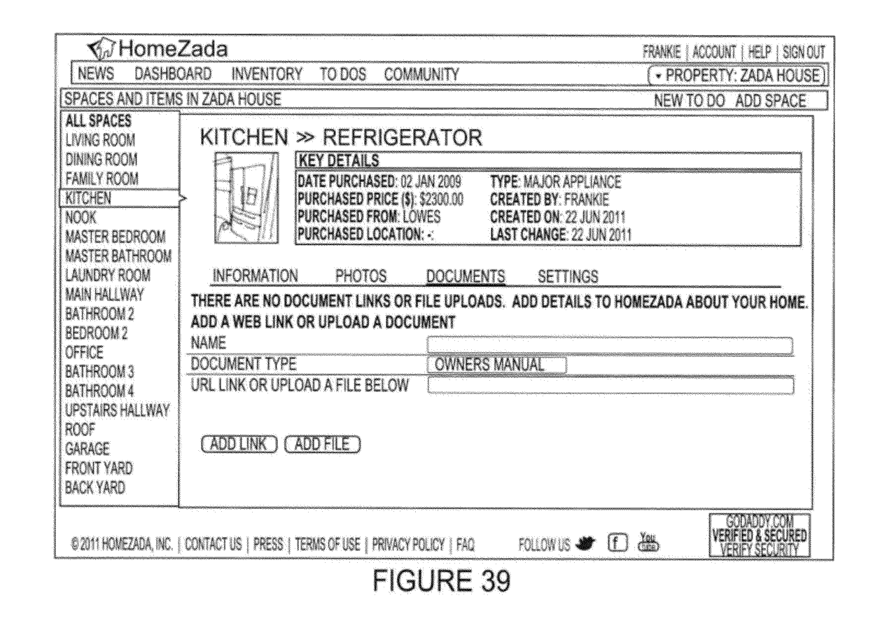

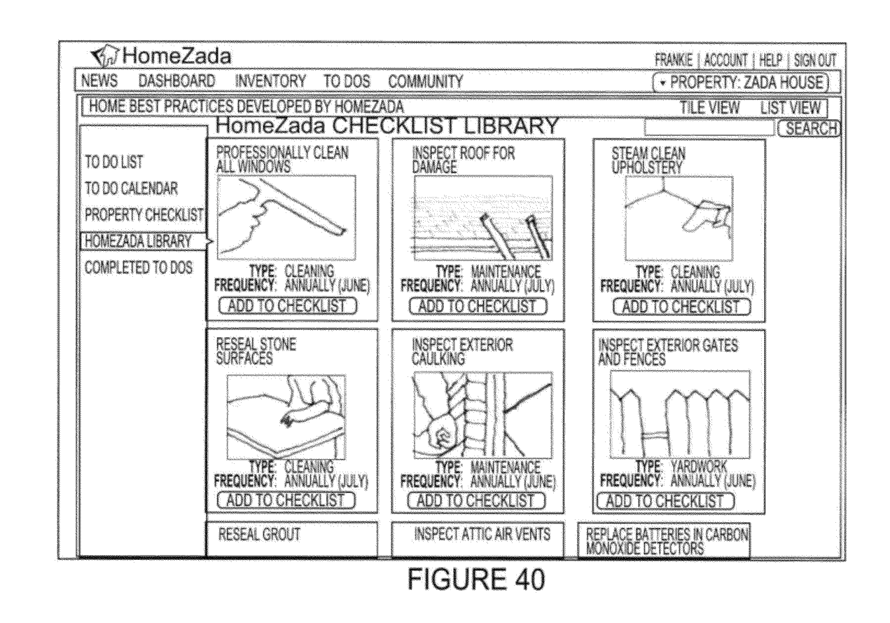

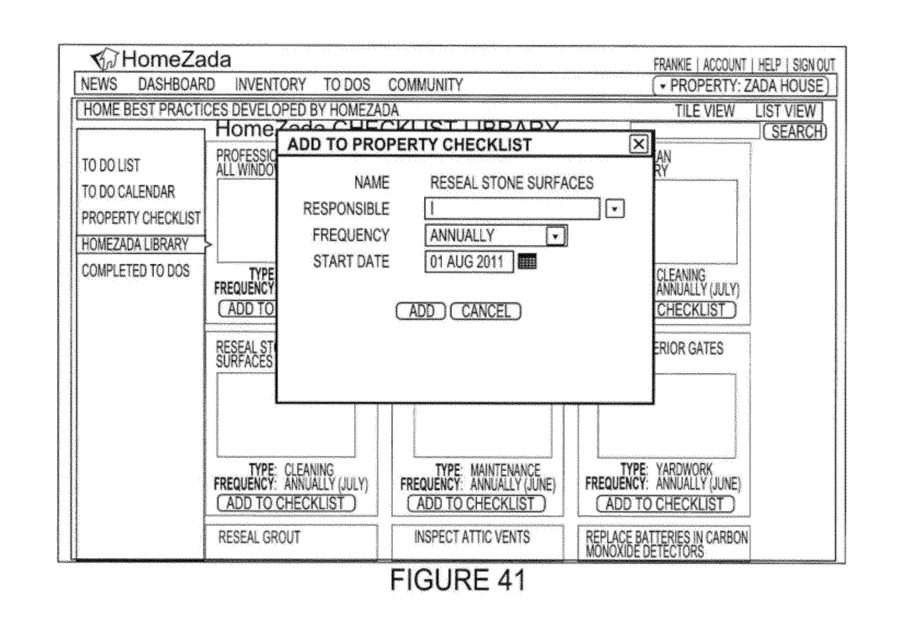

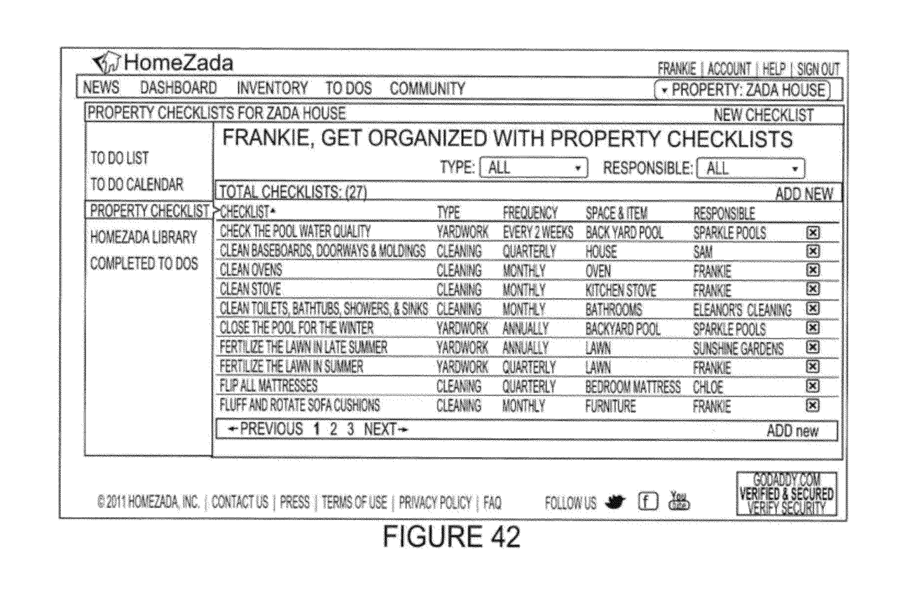

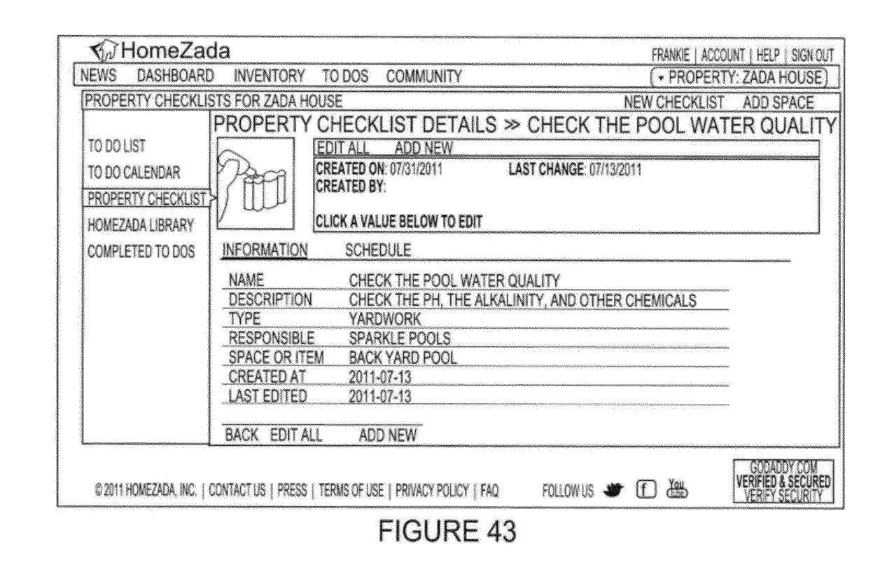

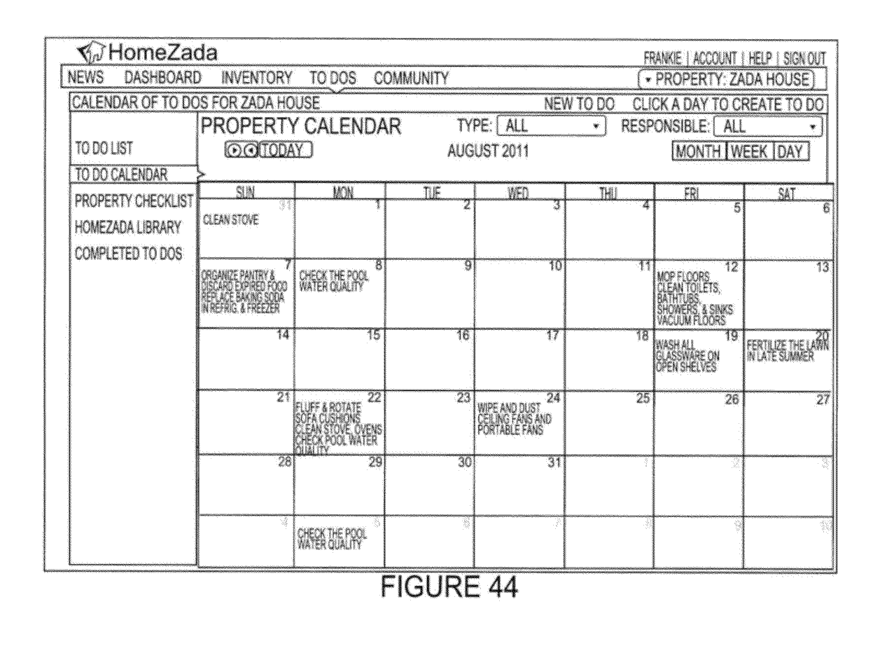

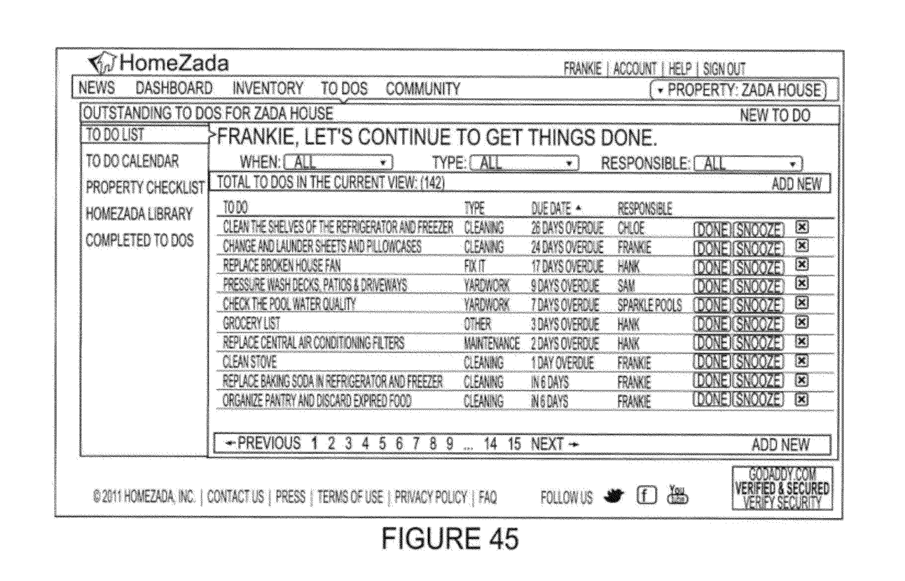

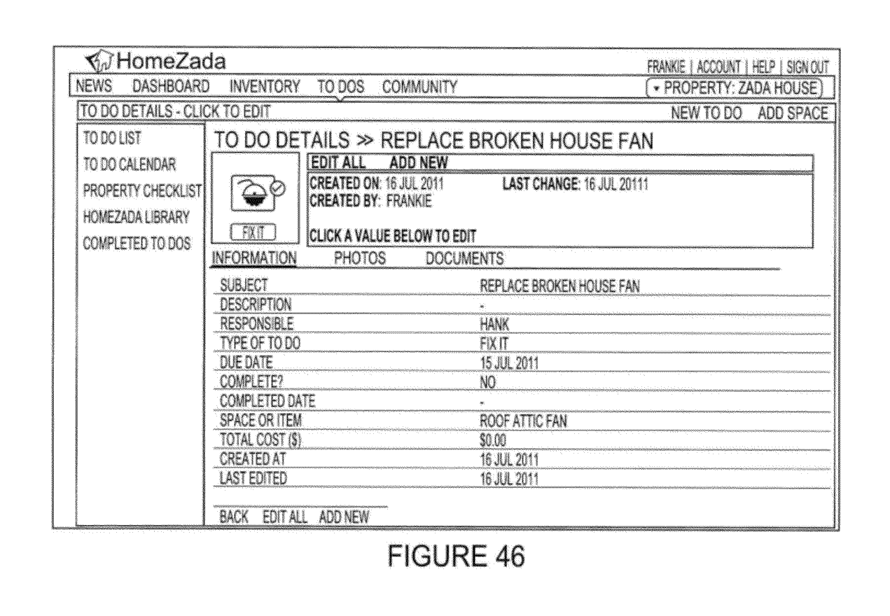

FIGS. 26A-26B are examples of the implementation of a web-based property asset system. One implementation is shown in FIG. 26A in which the system 109 that includes one or more user computing devices 102, such as computing devices 102a, 102b, . . . , 102n, that are capable of establishing a session and communicating with a property asset unit 104 as described below over a link 110. The link 110 may be a wired or wireless link, such as the Internet or World Wide Web, cellular network, digital data network, etc., wherein the computing devices and the property asset unit 104 establish a session and communicate with each other using a known protocol, such as HTTP or HTTPS or other protocols. However, the system is not limited to any particular link as the system may use any communications link, such as a landline or cellular link, or any network link, such as a local area network, wide area network, etc.

Each computing device 102 may be a processing unit based device that has sufficient processing power, memory, display capabilities and wireless/wired connectivity circuitry to interact with the property asset unit 104. For example, each computing device 102 may be a personal computer, a terminal, a laptop computer, a mobile device, a pocket PC device, a smartphone (RIM Blackberry, Apple iPhone, etc.), tablet computer, a mobile phone, a mobile email device, etc. Each computing device 102 may also include a typical browser application 111, such as browser applications 111a, 111b, . . . 111n, that may be, in the exemplary web-based client/server implementation, a web browser application (a plurality of lines of computer code stored in the computing device and executed by the processing unit of the computing device) that interacts with the property asset 104 and generates displays with information from the property asset unit 104.

The property asset unit 104, in one implementation may be implemented as one or more well known server computers (with the typical well known server computer components) that execute one or more pieces of software. In the web-based example shown in FIG. 14, the property asset unit 104 may include a software-based web server 112, such as an Internet Information servers or Apache web servers, executed by the processing unit(s) of the one or more server computer that establish the communications session with each computing device and browser, generate the web-pages downloaded to each computing device 102 and receives the data/information from each computing device. The web server 112 can handle multiple simultaneous communication sessions with a plurality of computing devices. The property asset unit 104 may also include an asset unit 113, implemented as a piece of software executed by the processing unit(s) of the one or more server computer(s) in this implementation that, among other things, stores the assets for each home/property as described below and provides the additional features of the property asset unit as described below in more detail.

The system 109 may further include a data store 114, implemented as one or more databases hosted on one or more database servers in the illustrated implementation (implemented in hardware and/or software that may be part of the unit 104 or remotely located from the unit 104 and may or may not be owned/controlled by the owner of unit 104) that includes, among other things, a record of the assets for each user of the system as described below as well as other data used by the system.

In addition, although a typical client/server architecture using web pages is shown in FIG. 26A above, the system can also be implemented as a hosted system, software as a service (SaaS) model, as a stand-alone system executing a plurality of lines of computer code, as software delivered to a piece of media to a customer and any other architecture as the system is not limited to any particular architecture.

FIG. 26B illustrates another implementation of the system 1000 in which the system has one or more computing devices that may include, in this implementation for example, personal computers 1001 with a browser, tablet computers 1002 (with a property asset system mobile application 69) and mobile smartphones 1003 (with a property asset system mobile application 69) that are capable of establishing a session and communicating with a property asset unit 1005-1011 as described below over a link 1004 that may be the public interne for example.

In this implementation, the property asset unit may have a firewall and network infrastructure 1005 that routes/manages each computing device that connects to the property asset unit. The property asset unit may further include one or more web servers 1006 that host the public property asset system website 1007 and the property asset system application 1008 that has been described above in detail. Similar to above, the application may be executed by the processing unit(s) of the one or more server computer that establish the communications session with each computing device and browser, generate the web-pages downloaded to each computing device 102 and receives the data/information from each computing device. The web servers 112 can handle multiple simultaneous communication sessions with a plurality of computing devices.

In this implementation, the property asset unit may also have one or more database servers 1009 (that store the HomeZada property asset databases 1010) and one or more file servers 1011 (that provide file storage 1012) that communicate with the property asset unit. As with the other implementation, these systems store a record of the assets for each user of the system as described below as well as other data used by the system.

In addition, although a typical client/server architecture using web pages is shown in FIG. 26B above, the system can also be implemented as a hosted system, software as a service (SaaS) model, as a stand-alone system executing a plurality of lines of computer code, as software delivered to a piece of media to a customer and any other architecture as the system is not limited to any particular architecture.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An property asset system, comprising:
a store containing a plurality of assets associated with a property, each asset being one of a fixed item asset and a possession asset, where both assets are contained within spaces and each space is a physical location in one of on the property and within a house, the fixed item asset is a property asset that is embedded into the property and the possessions asset is an asset that is removable from the property when sold;
an asset managing unit that permits a user to assign a maintenance plan to an asset;
wherein the asset managing unit further comprises a project system that tracks one or more property projects, a to do item system that manages to do items for the property project, a dashboard system that provides the user with a overview of the plurality of assets associated with the property, and a directory of businesses that can work on the property projects.

2. The system of claim 1, wherein the store contain a set of electronic records for each asset associated with a property.

3. The system of claim 1 further comprising one or more computing devices that are capable of accessing and interacting with the asset managing unit over a link.

4. The system of claim 3, wherein each computing device is one of a smartphone, a personal computer, a tablet computer, a terminal, a laptop computer, a mobile device, a pocket PC device, a mobile phone and a mobile email device.

5. The system of claim 4, wherein the tablet computer and the smartphone each further comprises an application executed by a processing unit of one of the tablet computer and the smartphone that interacts with the asset managing unit.

6. The system of claim 1, wherein the property is one of a single family home, a townhouse, a condominium, an estate, a ranch, an office building and wherein each property has one or more spaces and each asset is assigned to a space in the property.

7. The system of claim 6, wherein when a user creates a new property of a particular type including the number of bedrooms and bathrooms and the system is pre-populated based on the type of property with spaces, fixed item assets, and possession assets so the user does not have to manually enter each fixed item asset and possession asset into the system.

8. The system of claim 1, wherein each asset has a set of attributes that comprises one or more of an equipment manual, a serial number, the manufacturer's name, a warranty expiration date, a date of purchase and an initial cost of purchase.

9. The system of claim 8, wherein the set of attributes further comprises one of an electronic picture of the asset, a video of the asset and documents associated with the asset.

10. The system of claim 8, wherein each asset item can be setup to interface with an appropriate third party internet control interface thus providing a portal to view such asset from within the system.

11. The system of claim 1, wherein the asset managing unit further comprises a to do item system that tracks to do items associated with the property.

12. The system of claim 11, wherein the to do item system automatically generates to do items based on a property checklist with a scheduled frequency and an ad hoc to do item.

13. The system of claim 12, wherein the to do item system associates each to do item with an asset of the property and a person to complete the to do item.

14. The system of claim 1, wherein the asset managing unit further comprises a news and alerts system that generates news and alerts for a user of the system, the news and alerts are one of a reminder, an inventory suggestion, a property checklist suggestion, a home safety tip and a product tip.

15. The system of claim 1, wherein the asset managing unit further comprises an administrative system that maintains a set of attributes of the property and permits third party access to a particular part of the property record.

16. The system of claim 1, wherein the asset managing unit further comprises a community system to share information between the users of the asset managing system, wherein sharing information further comprises one of sharing a community property checklist, publishing contact information of a service provider, providing a referral to a service provider, creating a virtual neighborhood watch, showing a map with other users of the asset managing unit and generating incident reports.

17. The system of claim 1, wherein the asset managing unit further comprises a property checklist system that generates a property checklist for the property which in turn generates to do items.

18. The system of claim 15, wherein the administrative system transfers a set of property information and fixed asset information for the property from a seller to a buyer when the property is sold.

19. The system of claim 15, wherein the administrative system does not transfer the personal possession inventory items.

20. The system of claim 15, wherein the administrative system allows the user to merge the transferred set of property information and fixed asset information with the personal possession inventory items.

21. The system of claim 15, wherein the administrative system allows the user to make their property publicly available to share information when the user desires to sell their home

22. The system of claim 21, wherein the system allows the user to make a property, its spaces and its fixed item assets publicly available to view from prospective buyers while still maintaining the user's privacy of their possession items.

23. The system of claim 1, wherein the system allows authorized affiliate partners to create properties and their associated assets and maintenance plans and then transfer these properties to their home owner customers for ongoing use and management of their property.

24. The system of claim 1, wherein the system allows the user to manage design items, budget items, commitments items, and financial information for home improvement projects within the property.

25. The system of claim 24, wherein the system allows the user to link design items within a project to existing spaces, fixed item assets, and possession item assets as well as automatically create new spaces, fixed item assets, and possession item assets.

26. The system of claim 1, wherein the system allows within one customer account the ability to manage multiple properties.

27. The system of claim 1, wherein the systems allows multiple users access to the same customer account and thus allows all the users of a family household to share the property checklist calendar.

28. An property asset management method, the method comprising:
storing, for a plurality of assets associated with a property, as asset record each asset being one of a fixed item asset and a possession asset, where both assets are contained within spaces and each space is a physical location in one of on the property and within a house, the fixed item asset is a property asset that is embedded into the property and the possessions asset is an asset that is removable from the property when sold;
assigning, using an asset managing unit, a maintenance plan to an asset;
tracking, using a project system, one or more property projects;
managing, using a work order system, work orders for the property project;
providing, using a dashboard system, a overview of the plurality of assets associated with the property; and
providing a directory of businesses that can work on the property projects.

29. The method of claim 28, wherein the property is one of a single family home, a townhouse, a condominium, an estate, a ranch, an office building and wherein each property has one or more spaces and each asset is assigned to a space in the property.

30. The method of claim 28 further comprising creating a new property of a particular type including the number of bedrooms and bathrooms and the store is pre-populated based on the type of property with spaces, fixed item assets, and possession assets so the user does not have to manually enter each fixed item asset and possession asset into the store.

31. The method of claim 28, wherein each asset has a set of attributes that comprises one or more of an equipment manual, a serial number, the manufacturer's name, a warranty expiration date, a date of purchase and an initial cost of purchase.

32. The method of claim 31, wherein the set of attributes further comprises one of an electronic picture of the asset, a video of the asset and documents associated with the asset.

33. The method of claim 31, wherein each asset item can be setup to interface with an appropriate third party internet control interface thus providing a portal to view such asset from within the method.

34. The method of claim 28 further comprising providing a to do item system that tracks to do items associated with the property.

35. The method of claim 34, wherein the to do item system automatically generates to do items based on a property checklist with a scheduled frequency and an ad hoc to do item.

36. The method of claim 35, wherein the to do item system associates each to do item with an asset of the property and a person to complete the to do item.

37. The method of claim 28 further comprising generating, using a news and alerts system, news and alerts for a user of the system, the news and alerts are one of a reminder, an inventory suggestion, a property checklist suggestion, a home safety tip and a product tip.

38. The method of claim 28 further comprising maintaining a set of attributes of the property and permitting third party access to a particular part of the property record.

39. The method of claim 28 further comprising sharing, using a community system of the asset managing unit, information between the users of the asset managing method, wherein sharing information further comprises one of sharing a community property checklist, publishing contact information of a service provider, providing a referral to a service provider, creating a virtual neighborhood watch, showing a map with other users of the asset managing unit and generating incident reports.

40. The method of claim 28 further comprising generating a property checklist for the property which in turn generates to do items.

41. The method of claim 28 further comprising transferring a set of property information and fixed asset information for the property from a seller to a buyer when the property is sold.

42. The method of claim 41 further comprising maintaining personal possession inventory items when the property is sold.

43. The method of claim 28 further comprising allowing the user to merge the transferred set of property information and fixed asset information with the personal possession inventory items.

44. The method of claim 28 further comprising allowing the user to make their property publicly available to share information when the user desires to sell their home

45. The method of claim 28 further comprising allowing the user to make a property, its spaces and its fixed item assets publicly available to view from prospective buyers while still maintaining the user's privacy of their possession items.

46. The method of claim 28 further comprising allowing authorized affiliate partners to create properties and their associated assets and maintenance plans and then transfer these properties to their home owner customers for ongoing use and management of their property.

47. The method of claim 28 further comprising allowing the user to manage design items, budget items, commitments items, and financial information for home improvement projects within the property.

48. The method of claim 47 further comprising allowing the user to link design items within a project to existing spaces, fixed item assets, and possession item assets as well as automatically create new spaces, fixed item assets, and possession item assets.

49. The method of claim 28, wherein the system allows within one customer account the ability to manage multiple properties.

50. The method of claim 28, wherein the methods allows multiple users access to the same customer account and thus allows all the users of a family household to share the property checklist calendar.
